(19) United States
(12) Patent Application Publication
(10) Pub. No.: US 2009/0247404 A1
(43) Pub. Date: Oct. 1, 2009

(54) METHOD FOR IMPROVING HARVESTABILITY OF CROPS

(76) Inventors: James R. Bone, Valdosta, GA (US); Loston Rowe, Newark, DE (US); J. Dan Smith, Madison, MS (US); Charles Steven Williams, Madison, MS (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/158,694

(22) PCT Filed: Jan. 26, 2007
(86) PCT No.: PCT/US2007/002267

§ 371 Date: Oct. 17, 2008

Related U.S. Application Data
(60) Provisional application No. 60/764,539, filed on Feb. 2, 2006.
(60) Provisional application No. 60/765,542, filed on Feb. 6, 2006.

(51) Int. Cl. A01N 43/54; A01N 43/40; A01N 59/26; A01N 59/08; A01N 59/22; A01P 13/00

(52) U.S. Cl. 504/124; 504/239; 504/260; 504/128; 504/121

(57) ABSTRACT

Disclosed is a method for inhibiting regrowth of foliage of a crop plant being conditioned for harvest or after harvest comprising applying to the plant foliage a regrowth-inhibiting effective amount of a compound of Formula 1, an N-oxide or a salt thereof,

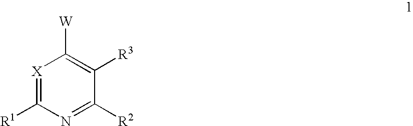

wherein
R¹, R², R³, W and X are as defined in the disclosure.
   Also disclosed is a harvest aid mixture for causing prolonged defoliation of a crop plant, such as cotton, being conditioned for harvest comprising a compound of Formula 1 and at least one compound acting as a defoliant or desiccant. Also disclosed is a method for inhibiting regrowth of foliage of a crop plant, such as cotton, comprising applying an effective amount of a compound of Formula 1 and at least one compound selected from compounds acting as a defoliant or desiccant. Also disclosed is an agricultural composition comprising a compound of Formula 1 and at least one additional active ingredient selected from the group consisting of a herbicide or insecticide and at least one of a surfactant, and a solid or liquid diluent.

### FIELD OF THE INVENTION

This invention relates to a method for improving harvestability of cultivated plants by using certain pyrimidines and pyridines.

### BACKGROUND OF THE INVENTION

Cultivated plants such as crops for food, feed, forage and fiber often benefit from treatment with certain chemicals to facilitate harvesting (i.e. improve harvestability) or to improve the quality of the harvested plant parts. Such chemical treatment before harvest is sometimes termed harvest conditioning, and the chemicals used are termed harvest aids. For example, sugarcane is often treated with chemicals to inhibit growth, resulting in an increase in sucrose concentration. Tobacco can be treated with chemicals to induce ripening of the leaves so that more can be harvested at one time. Chemical treatments can be used to cause desiccation or abscission of foliage to prevent interference with mechanical harvesting when natural senescence is insufficient. For example, potato plants are often chemically treated to desiccate haulms (i.e. stems and leaves) before harvesting potato tubers. Satisfactory mechanical harvesting of cotton particularly relies upon chemical treatment to remove potentially interfering or contaminating foliage and to open bolls (often called boll ripening or boll opening). As cotton is a perennial plant, new shoots and leaves tend to emerge (called regrowth) on plants that have been defoliated or desiccated. This newly emerged plant tissue can also interfere with harvest or reduce the quality of the harvested part of the plant.

While many chemical products are available to defoliate or desiccate, few are available that can effectively limit regrowth. Furthermore, while many herbicidal chemicals are known that can kill perennial plants and thus eliminate the growth of new foliage, they are generally too slow acting to be useful for facilitating harvesting crops, give insufficient or unreliable results, or have unacceptable side effects such as damaging harvestable plant parts. Useful regrowth inhibition for crop plants thus is generally not expected from herbicidal compounds.

Among the many patent publications relating to herbicides, PCT Patent Publication WO 2005/063721, U.S. Patent Publication 2004/0198608 and U.S. Pat. No. 6,784,137 disclose certain pyrimidines and pyridines as being herbicidal. Remarkable utility for inhibiting regrowth in crop plants has now been discovered.

### SUMMARY OF THE INVENTION

This invention pertains to a method for inhibiting regrowth of foliage of a crop plant being conditioned for harvest or after harvest comprising applying to the plant foliage a regrowth-inhibiting effective amount of a compound of Formula 1, an N-oxide or a salt thereof:

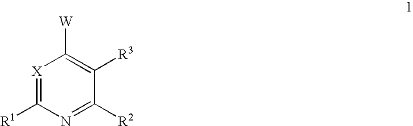

wherein
R¹ is halogen; or C₁-C₄ alkyl, C₂-C₄ alkenyl, C₃-C₅ cycloalkyl, C₂-C₆ alkoxyalkyl, C₂-C₆ alkylthioalkyl, each optionally substituted with 1-5 R⁵; or a phenyl or 5- or 6-membered heteroaromatic ring, each ring optionally substituted with 1 to 3 substituents independently selected from R⁶;
R² is ((O)ⱼC(R¹⁵)(R¹⁶))ₖR;
R is CO₂H or a regrowth-inhibiting effective derivative thereof,
R³ is halogen, cyano, thiocyano, nitro, C₁-C₆ alkyl, C₁-C₆ haloalkyl, OR⁷, SR⁸ or N(R⁹)R¹⁰;
W is H, —N(R¹¹)R¹², N₃ or —NO₂;
X is N or CR⁴;
R⁴ is H, halogen, C₁-C₆ alkyl, C₁-C₆ haloalkyl, C₁-C₆ alkoxy, C₁-C₆ haloalkoxy, C₁-C₆ alkylthio, phenoxy, nitro, cyano or thiocyano;
each R⁵ is independently halogen, C₁-C₆ alkyl, C₁-C₆ haloalkyl, C₂-C₆ alkenyl, C₂-C₆ haloalkenyl, C₁-C₃ alkoxy, C₁-C₂ haloalkoxy, C₁-C₃ alkylthio or C₁-C₂ haloalkylthio;
each R⁶ is independently halogen, cyano, nitro, C₁-C₄ alkyl, C₁-C₄ haloalkyl, C₃-C₆ cycloalkyl, C₃-C₆ halocycloalkyl, C₁-C₄ hydroxyalkyl, C₂-C₄ alkoxyalkyl, C₂-C₄ haloalkoxyalkyl, C₂-C₄ alkenyl, C₂-C₄ haloalkenyl, C₂-C₄ alkynyl, C₂-C₄ haloalkynyl, hydroxy, C₁-C₄ alkoxy, C₁-C₄ haloalkoxy, C₂-C₄ alkenyloxy, C₂-C₄ haloalkenyloxy, C₃-C₄ alkynyloxy, C₃-C₄ haloalkynyloxy, C₁-C₄ alkylthio, C₁-C₄ haloalkylthio or C₃-C₆ trialkylsilyl;
R⁷ is H, C₁-C₄ alkyl, C₁-C₃ haloalkyl or phenyl;
R⁸ is H, C₁-C₄ alkyl or C₁-C₃ haloalkyl;
R⁹ and R¹⁰ are independently H or C₁-C₄ alkyl;
R¹¹ is H, C₁-C₄ alkyl, C₁-C₄ haloalkyl, C₃-C₆ cycloalkyl, C₃-C₆ halocycloalkyl, C₁-C₄ hydroxyalkyl, C₂-C₄ alkoxyalkyl, C₂-C₄ haloalkoxyalkyl, C₂-C₄ alkenyl, C₂-C₄ haloalkenyl, C₃-C₄ alkynyl, C₃-C₄ haloalkynyl, C(═O)R³³ or nitro;
R¹² is H, C₁-C₄ alkyl optionally substituted with 1-2 R³⁰ or C(═O)R³³; or
R¹¹ and R¹² are taken together as a radical selected from —(CH₂)₄—, —(CH₂)₅—, —CH₂CH═CHCH₂— and —(CH₂)₂—O—(CH₂)₂—, each radical optionally substituted with 1-2 R⁴⁰;
R¹⁵ is H, halogen, C₁-C₄ alkyl, C₁-C₄ haloalkyl, hydroxy, C₁-C₄ alkoxy or C₂-C₄ alkylcarbonyloxy;
R¹⁶ is H, halogen, C₁-C₄ alkyl or C₁-C₄ haloalkyl; or
R¹⁵ and R¹⁶ are taken together as an oxygen atom to form, with the carbon atom to which they are attached, a carbonyl moiety;
each R³⁰ is independently halogen, C₁-C₃ alkoxy, C₁-C₃ haloalkoxy, C₁-C₃ alkylthio, C₁-C₃ haloalkylthio, amino, C₁-C₃ alkylamino, C₂-C₄ dialkylamino or C₂-C₄ alkoxycarbonyl;
each R³³ is independently H, C₁-C₁₄ alkyl, C₁-C₃ haloalkyl, C₁-C₄ alkoxy, phenyl, phenoxy or benzyloxy;
each R⁴⁰ is independently halogen, C₁-C₃ alkyl, C₁-C₃ alkoxy, C₁-C₃ haloalkoxy, C₁-C₃ alkylthio, C₁-C₃ haloalkylthio, amino, C₁-C₃ alkylamino, C₂-C₄ dialkylamino or C₂-C₄ alkoxycarbonyl;
j is 0 or 1; and
k is 0 or 1;
   provided that:
(a) when k is 0, then j is 0;
(b) when R² is CH₂OR^{a} wherein R^{a} is H, optionally substituted alkyl or benzyl, then R³ is other than cyano;
(c) when R¹ is phenyl substituted by Cl in each of the meta positions, the phenyl is also substituted by R⁶ in the para position; and
(d) when R¹ is phenyl substituted by R⁶ in the para position, said R⁶ is other than tert-butyl, cyano or optionally substituted phenyl.

More particularly, this invention pertains to a harvest aid mixture for causing prolonged defoliation of a crop plant, such as cotton, being conditioned for harvest comprising a compound of Formula 1 and at least one compound acting as a defoliant or desiccant.

This invention further relates to a method for inhibiting regrowth of foliage of a crop plant, such as cotton, comprising applying an effective amount of a compound of Formula 1 and at least one compound selected from compounds acting as a defoliant or desiccant.

This invention also relates to an agricultural composition comprising a compound of Formula 1 and at least one additional active ingredient selected from the group consisting of a herbicide or insecticide and at least one of a surfactant, and a solid or liquid diluent.

### DETAILS OF THE INVENTION

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “optionally substituted” in connection with groups listed for R¹, R¹², R⁵¹, R⁵⁷, R⁵⁸ and R⁶¹ refers to groups that are unsubstituted or have at least one non-hydrogen substituent.

In the above recitations, the term “alkyl”, used either alone or in compound words such as “alkylthio” or “haloalkyl” includes straight-chain or branched alkyl, such as, methyl, ethyl, n-propyl, i-propyl, or the different butyl, pentyl or hexyl isomers. “Alkenyl” includes straight-chain or branched alkenes such as ethenyl, 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as ethynyl, 1-propynyl, 2-propynyl and the different butynyl, pentynyl and hexynyl isomers. “Alkynyl” can also include moieties comprised of multiple triple bonds such as 2,5-hexadiynyl. “Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkenyloxy” includes straight-chain or branched alkenyloxy moieties. Examples of “alkenyloxy” include H₂C═CHCH₂O, (CH₃)CH═CHCH₂O and CH₂═CHCH₂CH₂O. “Alkynyloxy” includes straight-chain or branched alkynyloxy moieties. Examples of “alkynyloxy” include HC≡CCH₂O, CH₃C≡CCH₂O and CH₃C≡CCH₂CH₂O. “Alkylthio” includes branched or straight-chain alkylthio moieties such as methylthio, ethylthio, and the different propylthio, butylthio, pentylthio and hexylthio isomers. “Alkylamino”, “dialkylamino”, and the like, are defined analogously to the above examples. Examples of “alkoxycarbonyl” include CH₃C(═O), CH₃CH₂C(═O), CH₃CH₂CH₂C(═O) and (CH₃)₂CHOC(═O). “Cycloalkyl” includes, for example, cyclopropyl, cyclobutyl, cyclopentyl, and cyclohexyl.

“—CHO(CH₂)ₚ” means

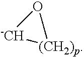

Aromatic indicates that each of the ring atoms is essentially in the same plane and has a p-orbital perpendicular to the ring plane, and in which (4n+2) π electrons, when n is a positive integer, are associated with the ring to comply with Hückel's rule. The terms “heteroaromatic ring” includes fully aromatic heterocycles. A wide variety of synthetic methods are known in the art to enable preparation of aromatic and nonaromatic heterocyclic rings and ring systems; for extensive reviews see the eight volume set of Comprehensive Heterocyclic Chemistry, A. R. Katritzky and C. W. Rees editors-in-chief, Pergamon Press, Oxford, 1984 and the twelve volume set of Comprehensive Heterocyclic Chemistry II, A. R. Katritzky, C. W. Rees and E. F. V. Scriven editors-in-chief, Pergamon Press, Oxford, 1996. The heteroaromatic rings can be attached through any available carbon or nitrogen by replacement of a hydrogen on said carbon or nitrogen.

One skilled in the art will appreciate that not all nitrogen-containing heterocycles can form N-oxides since the nitrogen requires an available lone pair of electrons for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The terms “haloalkenyl”, “haloalkynyl”, “haloalkoxy”, “haloalkylthio”, and the like, are defined analogously to the term “haloalkyl”. Examples of “haloalkenyl” include (Cl)₂C═CHCH₂ and CF₃CH₂CH═CHCH₂. Examples of “haloalkynyl” include HC≡CCHCl, CF₃C≡C, CCl₃C≡C and FCH₂C≡CCH₂. Examples of “haloalkoxy” include CF₃O, CCl₃CH₂O, HCF₂CH₂CH₂O and CF₃CH₂O. Examples of “haloalkylthio” include CCl₃S, CF₃S, CCl₃CH₂S and ClCH₂CH₂CH₂S.

The total number of carbon atoms in a substituent group is indicated by the “Cᵢ-Cⱼ” prefix where i and j are numbers from 1 to 14. For example, C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂. In the above recitations, when a compound of Formula 1 is comprised of one or more heterocyclic rings, all substituents are attached to these rings through any available carbon or nitrogen by replacement of a hydrogen on said carbon or nitrogen.

When a compound is substituted with a substituent bearing a subscript that indicates the number of said substituents can vary, when the number of said substituents is greater than 1, said substituents are independently selected from the group of defined substituents. When a group contains a substituent which can be hydrogen, for example W, R⁴, R⁷ through R¹², R¹⁵, R¹⁶, R³³, R⁵¹, R⁵², R⁵⁵ through R⁵⁹ and R⁶⁴, then, when this substituent is taken as hydrogen, it is recognized that this is equivalent to said group being unsubstituted.

Compounds relating to the mixtures, compositions and methods of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds of the invention may be present as a mixture of stereoisomers, individual stereoisomers, or as an optically active form.

The compounds of Formula 1 wherein R is CO₂H (i.e. a carboxylic acid function) are believed to be the compounds that bind to an active site on a plant enzyme or receptor causing inhibition of regrowth of the plant. Other compounds of Formula 1 wherein the substituent R is a group that can be transformed within plants or the environment to a carboxylic acid function (i.e. CO₂H) provide similar regrowth-inhibiting effects and are within the scope of the present invention. Therefore “regrowth-inhibiting effective derivative of the carboxylic acid” when used to describe the substituent R in Formula 1 is defined as any salt, ester, carboxamide, acyl hydrazide, imidate, thioimidate, amidine, acyl halide, acyl cyanide, acid anhydride, ether, acetal, orthoester, carboxaldehyde, oxime, hydrazone, thioacid, thioester, dithiolester, nitrile or any other carboxylic acid derivative known in the art which does not extinguish the regrowth-inhibiting activity of the compound of Formula 1 and is or can be hydrolyzed, oxidized, reduced or otherwise metabolized in plants or soil to provide the carboxylic acid function, which depending upon pH, is in the dissociated or the undissociated form.

Agriculturally suitable salts of the compounds relating to the mixtures, compositions and methods of the invention are salts formed by contact with acids or bases or through ion exchange such that the derived salts retain sufficient water solubility for bioavailability and thus regrowth-inhibiting efficacy and that the counterions of the salts are suitable for use in agriculture. The agriculturally suitable salts of the compounds of the invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. The agriculturally suitable salts of the compounds of the invention also include those formed with organic bases (e.g., pyridine, ammonia, triethylamine or quaternary ammonium) or inorganic bases (e.g., hydrides, hydroxides, or carbonates of sodium, potassium, lithium, calcium, magnesium or barium) when the compound contains an acidic group such as a carboxylic acid or phenol. One skilled in the art recognizes that because in the environment and under physiological conditions salts of the compounds of the invention are in equilibrium with their corresponding nonsalt forms, agriculturally suitable salts share the biological utility of the nonsalt forms. Accordingly, the present invention comprises compounds selected from Formula 1 and their N-oxides and agriculturally suitable salts thereof.

Particularly useful are regrowth-inhibiting effective derivatives of compounds of Formula 1 wherein R is CO₂H formed with strong bases or amines. As is well known in the art, contact of a carboxylic acid group (CO₂H) with a base causes deprotonation to give the corresponding carboxylate ion (CO_{2′}) and a typically positively charged counterion derived from the base. The combination of the carboxylate ion and the counterion constitute a salt derivative of the carboxylic acid group. An extensive range of counterions form regrowth-inhibiting effective derivatives of compounds of Formula 1 wherein R is CO₂H, as most of the derived salts have sufficient water solubility for bioavailability. Illustrative and of particular note are salts of compounds of Formula 1 in which R is CO₂H wherein the counterion ion is an alkali metal cation such as lithium, sodium or potassium, quaternary ammonium such as tetramethylammonium, ternary sulfonium such as trimethylsulfonium, or derived from an amine such as dimethylamine, diethanolamine(diolamine) or triethanolamine(trolamine).

Also particularly useful are ester and thioester derivatives of CO₂H as R in the compounds of Formula 1. As is well known in the art, ester groups (i.e. CO₂R^{AL}) result from condensation of a carboxylic acid function (CO₂H) with an alcohol (i.e. R^{AL}OH) wherein R^{AL} is the radical derived from the alcohol; a wide range of methods are known to prepare such esters. Analogously, thioester groups of formula C(O)SR^{AL} may be conceptually viewed as the condensation product of a carboxylic acid function with a thioalcohol (often called a mercaptan) of formula R^{AL}SH; a variety of methods are known to prepare such thioesters. As compounds of Formula 1 wherein R is CO₂H are effective regrowth inhibitors, and their derived esters and thioesters are susceptible to hydrolysis (to R being CO₂H), particularly in the presence of hydrolytic enzymes, the compounds of Formula 1 wherein R is an ester (i.e. CO₂R^{AL}) or thioester (i.e. C(O)SR^{AL}) are generally useful as regrowth inhibitors. Of the regrowth-inhibiting effective derivatives of CO₂H, the ester and thioester derivatives, particularly ester derivatives, are among the most conveniently prepared and useful. If the radical R^{AL} has more than one OH or SH function, the radical may then be condensed with more than one pyrimidine or pyridine ring system of Formula 1 having CO₂H as R. As the derived multiply esterified derivatives can be hydrolyzed to the compound of Formula 1 having CO₂H as R, said multiply esterified derivatives are among the regrowth-inhibiting effective derivatives of CO₂H. Illustrative and of note are ester and thioester compounds of Formula 1 in which R being CO₂H is esterified with methanol, ethanol, propanol, isopropanol, t-butanol and phenol to form methyl, ethyl, propyl, i-propyl, t-butyl and phenyl esters, respectively. Of particular note are the methyl and ethyl esters.

The term “foliage” refers to leaves, stems, flowers, fruits and other parts of plants not covered by or immersed in the growing medium. The term “foliar” is an adjective and means of or relating to foliage.

“Harvest conditioning” or “being conditioned for harvest” refers to the chemical treatment of crop plants prior to harvest to prepare them for harvest and to improve harvestability. The phrase “after harvest” refers to the period subsequent to gathering the harvestable portion of the crop and prior to preparing to plant the next crop. The term “harvestability” refers to the ability to rapidly and efficiently gather the harvestable portion of the crop while maintaining quality of the harvested portion, particularly using mechanical harvest devices. The term “harvest aid” refers to a chemical used advantageously to improve harvestability of cultivated plants, or increase quality of harvested plant parts, resulting, for example, in maximizing the collection of harvestable crop, achieving more efficient mechanical harvesting, or preserving high crop quality to provide maximum economic returns. Types of harvest aids include defoliant, desiccant, boll opener and regrowth inhibitor. It is well known that harvesting of certain crops may be aided by the use of substances that cause defoliation or desiccation of leaves thereby reducing the interference of leaves with harvesting personnel and machinery. For example, conditioning the cotton plant for harvest requires removal or desiccation of existing leaves and the prevention of the development of new leaves. Existing leaves are removed or conditioned either by defoliation or desiccation through the application of chemical products (harvest aids) as foliar sprays to the cotton plant. The defoliant and desiccant harvest aid products do not normally kill the cotton plant, but only result in the removal of existing leaves. “Defoliation” is the shedding of plant leaves, which ordinarily occurs when the leaves become senescent. Leaf shedding (abscission) results from activity of special cells at the base of the leaf petiole where it joins the stem. The “state of defoliation” refers to the condition of a plant that has shed its leaves. A “defoliant” is a chemical compound that either impacts plant hormonal activity related to leaf loss or causes direct injury to leaves, both at a level that promotes leaf drop (abscission). The activity of a defoliant typically varies by molecular structure and environmental conditions, but defoliants generally require days or weeks to remove leaves from the plants by causing leaves to abscise completely from the plant.

“Desiccation” is drying of plant tissues that can be caused by disruption of cell membranes and rapid loss of moisture. A “desiccant” refers to a contact-type herbicide that destroys cell membranes leading to rapid moisture loss and leaf desiccation, typically killing leaves rapidly with limited abscission. Desiccants produce quick injury that is more severe than that seen with defoliants, causing leaf dehydration and death within one to several days. Desiccants are often applied as a follow-up treatment after application of defoliants. Both desiccation and defoliation result in the absence of green leaves on a plant that is being conditioned for harvest. “Prolonged defoliation” is the extension of duration of a state of defoliation (or absence of green leaves) beyond that accomplished by applying a defoliant or desiccant.

A “boll opener” refers to a chemical compound that accelerates opening of mature bolls of cotton plants.

“Regrowth” is a term given to new leaves and stems produced by a plant after defoliation or desiccation. A “regrowth inhibitor” is a chemical compound applied to plants primarily to inhibit leaf and stem growth (regrowth) or to enhance or extend the state of defoliation resulting from the application of defoliants or desiccants. It is understood that when a regrowth inhibitor is applied concurrently or subsequently with a defoliant or desiccant, it results in extending the period without green leaves (state of defoliation), i.e. prolonged defoliation.

Cotton is a deciduous perennial plant. One skilled in the art will recognize, however, that cotton culture, as practiced in all major growing areas, involves the management of this perennial plant as an annual crop. As it is grown in commercial lint (fiber) and seed production worldwide, cotton has been selected and bred and is managed to exhibit a determinant nature to the extent that it is grown as an annual. The cotton plant is managed for its ability to go through a reproductive phase within one growing season with no commercial interest in its perennial nature. As a result, for the efficient harvest of the lint produced in the cotton bolls, the reproductive centers of the plant, artificial means, i.e. harvest aid chemicals, are used to prepare the plant for optimum harvestability. Being perennial, the cotton plant tends to initiate regrowth following defoliation or desiccation. This new growth is particularly problematic for cotton harvesting in that it is most often very lush, responds to defoliants less predictably than mature foliage, and frequently continues following defoliation. The new leaves interfere with harvest in two ways: (1) they reduce harvest efficiency, and (2) new foliage tends to stain the cotton lint, as well as adding foreign matter to and creating moisture problems in it, thereby reducing the lint's quality and ultimately value.

There are two kinds of regrowth in cotton: “Terminal regrowth” is the continuation or resumption of new growth in the growing point in the plant apex (apical meristem). Terminal regrowth frequently occurs following application of defoliants, desiccants and boll opening materials in preparation for cotton harvest. When foliage and immature fruit forms are removed from physiologically mature cotton plants under conditions of available moisture, fertility, and heat, the cotton plant often responds by initiating terminal regrowth. Terminal regrowth is a source of lint stain and foreign material during harvest, a source of excess moisture which limits seed cotton storage, provides sites for insect development, reduces harvest efficiency, and, finally, is aesthetically very objectionable. Harvest aids containing thidiazuron or combinations of thidiazuron and diuron are frequently used to limit terminal regrowth, with varying degrees of success.

“Basal regrowth” occurs when dormant axillary buds, primarily at main-stem nodes, germinate, usually following application of cotton harvest aids such as desiccants, defoliants and boll openers. Basal regrowth may occur in concert with terminal regrowth following any harvest aid application; however, it is most common following application of ethephon and ethephon/cyclanilide combinations for boll opening. These harvest aid materials appear to interfere with apical dominance in the cotton plant and under favorable conditions greatly increase the occurrence of basal regrowth. Basal regrowth causes all of the problems associated with terminal regrowth and potentially interferes with harvest efficiency to a greater extent than terminal regrowth. Basal regrowth tends to lag behind terminal regrowth initially; however, because it originates from many sites, it has the capacity to produce great amounts of foliage and/or reproductive forms relatively quickly. Regrowth inhibitors particularly effective on basal regrowth are few. Thidiazuron and thidiazuron/diuron combinations limit basal regrowth less effectively and less consistently than terminal regrowth.

In addition to conditioning the cotton plant for harvest, preventing the continuation or resumption of emergence of new leaves and stems (regrowth) after harvest is also important. Basal regrowth following harvest, or harvest followed by mowing, is a problem in much of the cotton belt in the southern U.S. At the lowest latitudes, basal regrowth will continue indefinitely, wasting soil fertility and moisture, and providing sites for regeneration of the boll weevil and other cotton insect pests. Establishment of a host-free period is a key insect management technique in many areas and requires maintaining the field free from live cotton plants for a period of several months after harvest. In more temperate environments, basal regrowth persists only until the first freeze. However, this period may extend for 30-90 days after harvest. Furthermore, the increased adoption of reduced tillage practices has accentuated the need for a chemical method of eliminating formation of new leaves and stems after harvest. 2,4-D applied to freshly cut stumps is often used to kill cotton stalks, and thifensulfuron-methyl/tribenuron-methyl combinations have been utilized after harvest to limit basal regrowth.

The present invention is effective for preventing regrowth when applied to a crop being conditioned for harvest or after harvest.

The present invention has been found to be effective for preventing any kind of regrowth including basal and terminal regrowth.

“Transgenic cotton” refers to cotton varieties that have been genetically modified to incorporate genes for useful traits from other species. For example transgenic cotton may incorporate genes for producing insecticidal proteins or herbicide tolerance. The cotton of the present invention includes transgenic cotton.

Embodiments of the present invention include:

### Embodiment A1

The method as set forth in the Summary of the Invention wherein in the compound of Formula 1
R² is ((O)ⱼC(R¹⁵)(R¹⁶))ₖR;
R is CO₂R⁵¹, CH₂OR⁵², CH(OR⁵³)(OR⁵⁴), CHO, C(═O)N(R⁵⁵)R⁵⁶, C(═S)OR⁵⁷, C(═O)SR⁵⁸ or C(═NR⁵⁹)YR⁶⁰;
R⁵¹ is H or a radical selected from C₁-C₁₄ alkyl, C₃-C₁₂ cycloalkyl, C₄-C₁₂ alkylcycloalkyl, C₄-C₁₂ cycloalkylalkyl, C₂-C₁₄ alkoxyalkyl, C₃-C₁₄ alkoxyalkoxyalkyl, C₂-C₁₄ hydroxyalkyl, C₂-C₁₄ alkenyl, C₂-C₁₄ alkynyl, benzyl and phenyl, each radical optionally substituted with 1-3 R⁶¹; or
R⁵¹ is a divalent radical linking the carboxylic ester function CO₂R⁵¹ of each of two pyrimidine ring systems of Formula 1, the divalent radical selected from —CH₂—, —(CH₂)₂—, —(CH₂)₃— and —CH(CH₃)CH₂—;
R⁵² is H, C₁-C₁₀ alkyl optionally substituted with 1-3 R⁶², or benzyl;
R⁵³ and R⁵⁴ are independently C₁-C₄ alkyl or C₁-C₃ haloalkyl; or
R⁵³ and R⁵⁴ are taken together as —CH₂CH₂—, —CH₂CH(CH₃)— or —(CH₂)₃—;
R⁵⁵ is H, C₁-C₄ alkyl, hydroxy or C₁-C₄ alkoxy;
R⁵⁶ is H or C₁-C₄ alkyl;
R⁵⁷ and R⁵⁸ are H; or a radical selected from C₁-C₁₄ alkyl, C₃-C₁₂ cycloalkyl, C₄-C₁₂ alkylcycloalkyl, C₄-C₁₂ cycloalkylalkyl, C₂-C₁₄ alkenyl and C₂-C₁₄ alkynyl, each radical optionally substituted with 1-3 R⁶¹;
Y is O, S or NR⁶⁴;
R⁵⁹ is H, C₁-C₃ alkyl, C₁-C₃ haloalkyl, C₂-C₄ alkoxyalkyl, OH or C₁-C₃ alkoxy;
R⁶⁰ is C₁-C₃ alkyl, C₁-C₃ haloalkyl or C₂-C₄ alkoxyalkyl; or
R⁵⁹ and R⁶⁰ are taken together as —(CH₂)₂—, —CH₂CH(CH₃)— or —(CH₂)₃—;
each R⁶¹ is independently halogen, cyano, hydroxycarbonyl, C₂-C₄ alkoxycarbonyl, hydroxy, C₁-C₄ alkoxy, C₁-C₄ haloalkoxy, C₂-C₈ alkoxyalkoxy, C₁-C₄ alkylthio, C₁-C₄ haloalkylthio, amino, C₁-C₄ alkylamino, C₂-C₄ dialkylamino, —CHO(CH₂)ₚ or phenyl optionally substituted with 1-3 R⁶³;
each R⁶² is independently halogen, C₁-C₄ alkoxy, C₁-C₄ haloalkoxy, C₁-C₄ alkylthio, C₁-C₄ haloalkylthio, amino, C₁-C₄ alkylamino or C₂-C₄ dialkylamino;
each R⁶³ is independently halogen, C₁-C₄ alkyl, C₁-C₃ haloalkyl, hydroxy, C₁-C₄ alkoxy, C₁-C₃ haloalkoxy, C₁-C₃ alkylthio, C₁-C₃ haloalkylthio, amino, C₁-C₃ alkylamino, C₂-C₄ dialkylamino or nitro;
R⁶⁴ is H, C₁-C₃ alkyl, C₁-C₃ haloalkyl or C₂-C₄ alkoxyalkyl; and
p is an integer from 1 to 4.

### Embodiment A2

The method of Embodiment A1 wherein R² is OCH₂CO₂R⁵¹.

### Embodiment A3

The method of Embodiment A1 wherein R² is CO₂R⁵¹, CH₂OR⁵², CHO or C(═O)N(R⁵⁵)R⁵⁶.

### Embodiment A4

The method of Embodiment A3 wherein R² is CO₂R⁵¹.

### Embodiment A5

The method of Embodiments A4 wherein R⁵¹ is H, C₁-C₁₀ alkyl, C₂-C₁₀ alkoxyalkyl, C₃-C₁₀ alkoxyalkoxyalkyl, C₂-C₁₀ hydroxyalkyl or benzyl.

### Embodiment A6

The method of Embodiment A5 wherein R⁵¹ is H, C₁-C₄ alkyl, C₂-C₄ alkoxyalkyl, C₃-C₄ alkoxyalkoxyalkyl, C₂-C₄ hydroxyalkyl or benzyl.

### Embodiment A7

The method of Embodiment A6 wherein R⁵¹ is H or C₁-C₂ alkyl.

### Embodiment A8

The method of Embodiment A5 wherein R⁵¹ is C₅-C₁₀ alkyl, C₅-C₁₀ alkoxyalkyl, C₅-C₁₀ alkoxyalkoxyalkyl or C₅-C₁₀ hydroxyalkyl.

### Embodiment A9

The method of Embodiment A8 wherein R⁵¹ is C₅-C₈ alkyl, C₅-C₈ alkoxyalkyl, C₅-C₈ alkoxyalkoxyalkyl or C₅-C₈ hydroxyalkyl.

### Embodiment A10

The method of Embodiment A3 wherein R² is CO₂H or a salt thereof.

### Embodiment A11

The method of Embodiment A10 wherein R² is CO₂H salt derivative.

### Embodiment A12

The method of Embodiment A1 wherein R² is CO₂H, a regrowth-inhibiting effective salt or an ester or thioester derivative thereof.

### Embodiment A13

The method of Embodiment A12 wherein R² is CO₂H, a regrowth-inhibiting effective salt or an ester derivative thereof.

### Embodiment A14

The method as set forth in the Summary of the Invention wherein in the compound of Formula 1 R¹ is halogen; or cyclopropyl or isopropyl, each optionally substituted with 1-2 R⁵.

### Embodiment A15

The method as set forth in the Summary of the Invention wherein in the compound of Formula 1 R¹ is a phenyl or 5- or 6-membered heteroaromatic ring, each optionally substituted with 1 to 3 substituents independently selected from R⁶.

### Embodiment A16

A compound of Embodiment A15 wherein R¹ is one of U-1 through U-50 depicted in Exhibit 1;

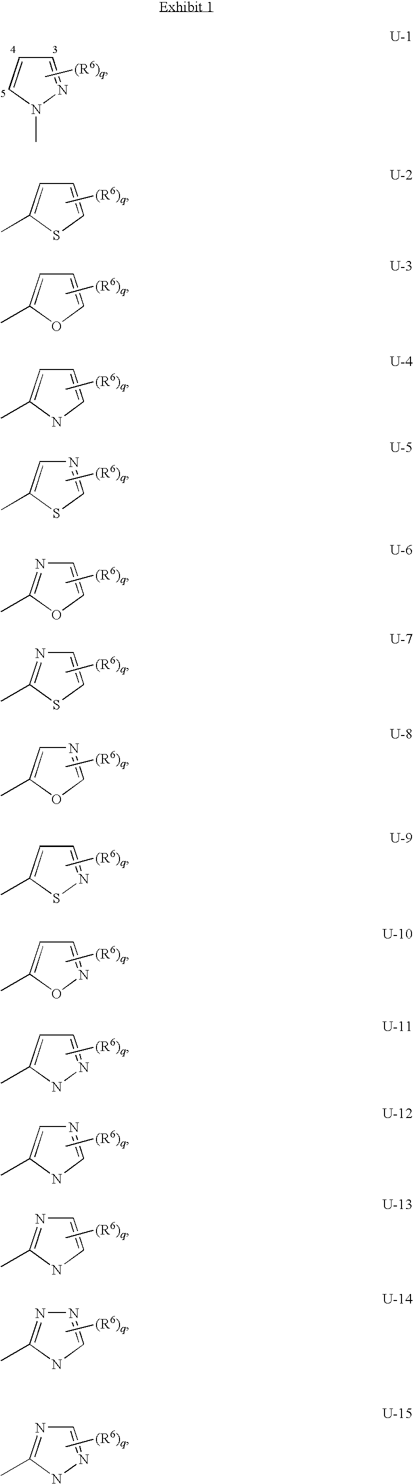

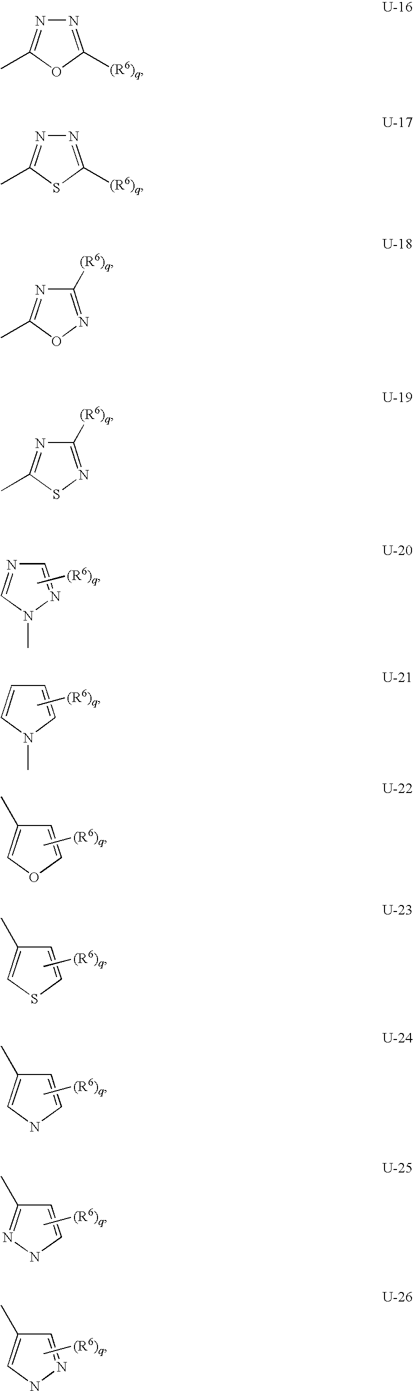

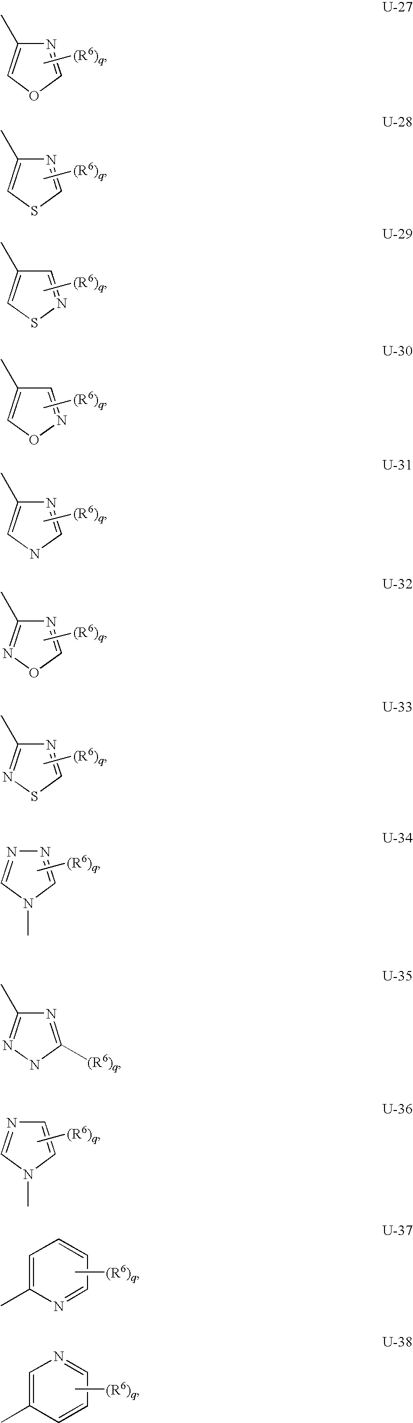

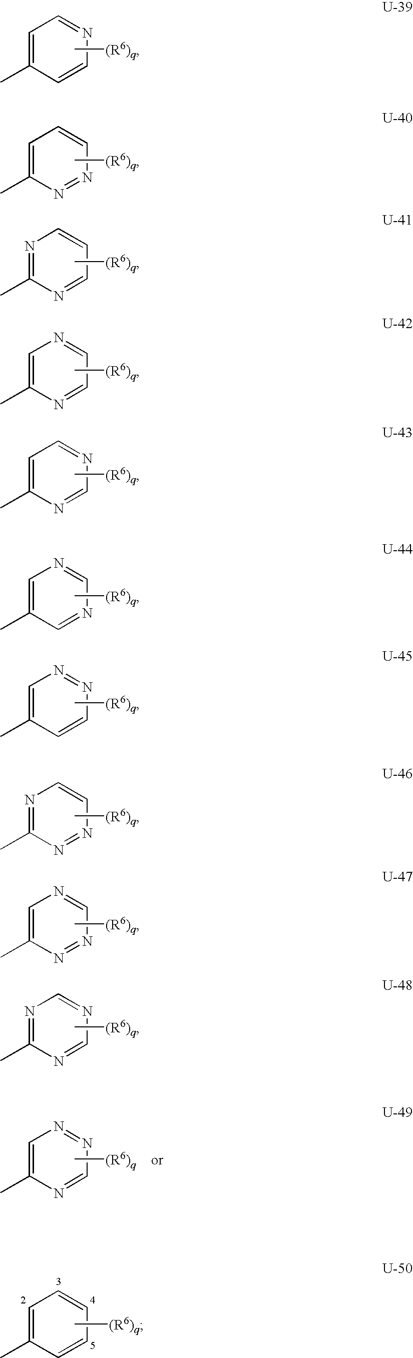

wherein
q is 0, 1, 2 or 3.

### Embodiment A17

The method of Embodiment A14 wherein R¹ is cyclopropyl optionally substituted with 1-2 R⁵.

### Embodiment A18

The method of Embodiment A14 wherein R¹ is isopropyl optionally substituted with 1-2 R⁵.

### Embodiment A19

The method of Embodiment A14 wherein R¹ is phenyl optionally substituted with 1-3 R⁶.

### Embodiment A20

The method of Embodiment A14 wherein R¹ is halogen.

### Embodiment A21

The method of Embodiment A20 wherein R¹ is Cl.

### Embodiment A22

The method of Embodiment A17 wherein R¹ is cyclopropyl.

### Embodiment A23

The method of Embodiment A19 wherein R¹ is phenyl substituted with a R⁶ radical in the para position and optionally with 1-2 R⁶ in other positions.

### Embodiment A24

The method of Embodiment A23 wherein R¹ is phenyl substituted with a halogen, methyl or methoxy radical in the para position and optionally with 1-2 radicals selected from halogen and methyl in other positions.

### Embodiment A25

The method of Embodiment A24 wherein R¹ is phenyl substituted with a halogen radical in the para position and optionally with 1-2 radicals selected from halogen and methyl in other positions.

### Embodiment A26

The method of Embodiment A25 wherein R¹ is phenyl substituted with a Br or Cl radical in the para position and optionally with 1-2 radicals selected from halogen and methyl in other positions.

### Embodiment A27

The method of Embodiment A26 wherein R¹ is phenyl substituted with a Br or Cl radical in the para position.

### Embodiment A28

The method as set forth in the Summary of the Invention wherein in the compound of Formula 1 R³ is F, Cl or Br.

### Embodiment A29

The method of Embodiment A26 wherein R³ is Cl.

### Embodiment A30

The method as set forth in the Summary of the Invention wherein in the compound of Formula 1 X is N.

### Embodiment A31

The method as set forth in the Summary of the Invention wherein in the compound of Formula 1 X is CR⁴.

### Embodiment A32

The method of Embodiment A31 wherein R⁴ is H, F, Cl or Br.

### Embodiment A33

The method of Embodiment A32 wherein R⁴ is H, F or Cl.

### Embodiment A34

The method of Embodiment A33 wherein R⁴ is H or Cl.

### Embodiment A35

The method of Embodiment A34 wherein R⁴ is H.

### Embodiment A36

The method as set forth in the Summary of the Invention wherein in the compound of Formula 1 W is H or —N(R¹¹)R¹².

### Embodiment A37

The method of Embodiment A36 wherein W is H.

### Embodiment A38

The method of Embodiment A36 wherein W is NH₂.

### Embodiment A39

The method of Embodiment A1 wherein each R⁶¹ is other than —CHO(CH₂)ₚ.

### Embodiment B1

The method as set forth in the Summary of the Invention comprising a compound of Formula 1 is applied with at least one compound selected from compounds acting as a defoliant or desiccant.

### Embodiment B2

The method as set forth in Embodiment B1 wherein the at least one defoliant or desiccant compound is selected from the group consisting of tribufos (S,S,S-tributylphosphorotrithioate), dimethipin, thidiazuron, diuron, carfentrazone-ethyl, pyraflufen, ethephon, cyclanilide, AMADS (1-aminomethanamide dihydrogen tetraoxosulfate), sodium chlorate, paraquat, glyphosate, endothal, cacodylic acid, urea phosphate and their agriculturally suitable salts.

### Embodiment B3

The method as set forth in Embodiment B2 wherein the at least one defoliant or desiccant compound is selected from the group consisting of tribufos, thidiazuron, ethephon, cyclanilide, AMADS, sodium chlorate, cacodylic acid, urea phosphate and their agriculturally suitable salts.

### Embodiment B4

The method as set forth in Embodiment B3 wherein for causing prolonged defoliation of a cotton plant being conditioned for harvest comprising a compound of Formula 1 and at least one compound selected from the group consisting of tribufos, thidiazuron, ethephon, cyclanilide, AMADS, sodium chlorate, cacodylic acid, urea phosphate and their agriculturally suitable salts.

### Embodiment B5

The method as set forth in Embodiment B2 wherein the component is tribufos.

### Embodiment B6

The method as set forth in Embodiment B2 wherein the component is thidiazuron.

### Embodiment B7

The method as set forth in Embodiment B2 wherein the component is a mixture of thidiazuron and diuron.

### Embodiment B8

The method as set forth in Embodiment B2 wherein the component is a mixture of thidiazuron and dimethipin.

### Embodiment B9

The method as set forth in Embodiment B2 wherein the component is ethephon.

### Embodiment B10

The method as set forth in Embodiment B2 wherein the component is a mixture of ethephon and cyclanilide.

### Embodiment B11

The method as set forth in Embodiment B2 wherein the component is a mixture of ethephon and AMADS.

### Embodiment B12

The method as set forth in Embodiment B2 wherein the component is sodium chlorate.

### Embodiment B13

The method as set forth in Embodiment B2 wherein the component is cacodylic acid.

### Embodiment B14

The method as set forth in Embodiment B2 wherein the component is a mixture of sodium cacodylate and cacodylic acid.

### Embodiment B15

The method as set forth in Embodiment B2 wherein the component is a mixture of ethephon and urea phosphate.

### Embodiment B16

A mixture comprising a compound of Formula 1 and a component consisting of at least one compound or mixture selected from the group consisting of tribufos, thidiazuron, ethephon, cyclanilide, AMADS, sodium chlorate, cacodylic acid, urea phosphate and their agriculturally suitable salts.

### Embodiment B 17

The method as set forth in any one of Embodiments B2-B16 wherein the compound of Formula 1 and the component consisting of at least one compound or mixture selected from the group of Embodiment B2 are in a weight ratio in the range of about 1:500 to 100:1.

### Embodiment B18

The method of Embodiment B17 wherein the compound of Formula 1 and the component consisting of at least one compound or mixture selected from the group of Embodiment B2 are in a weight ratio in the range of about 1:500 to 40:1.

### Embodiment B19

The method of Embodiment B18 wherein the compound of Formula 1 and the component consisting of at least one compound or mixture selected from the group of Embodiment B1 are in a weight ratio in the range of about 1:100 to 1:1.

### Embodiment B20

The method as set forth in the Summary of the Invention for inhibiting regrowth in a crop plant wherein the compound is applied to a crop plant being conditioned for harvest.

### Embodiment B21

The method of Embodiment B20 for inhibiting regrowth in a cotton plant wherein the compound is applied to a cotton plant being conditioned for harvest.

### Embodiment B22

The method of Embodiment B21 wherein the regrowth being inhibited is basal regrowth.

### Embodiment B23

The method of Embodiment B21 wherein the regrowth being inhibited is terminal regrowth.

### Embodiment B24

The method as set forth in the Summary of the Invention for inhibiting regrowth in a crop plant wherein the compound is applied after harvest.

### Embodiment B25

The method as set forth in the Summary of the Invention for inhibiting regrowth in a cotton plant wherein the compound is applied after harvest.

### Embodiment B26

The method Embodiment B25 wherein the regrowth being inhibited is basal regrowth.

### Embodiment B27

The method Embodiment B25 wherein the regrowth being inhibited is terminal regrowth.

### Embodiment C1

The method as set forth in the Summary of the Invention wherein the crop plant is selected from cotton, tuberous crops such as potato, beets and the like, citrus tree, tomato, pepper, tobacco, peanut and sugarcane.

### Embodiment C2

The method of Embodiment C1 wherein the crop plant is cotton.

Combinations of Embodiments A1-A39 are illustrated by:

### Embodiment A

The method as set forth in the Summary of the Invention or in Embodiment A1 wherein in the compound of Formula 1
R¹ is halogen; or C₁-C₃ alkyl or C₃-C₅ cycloalkyl, each optionally substituted with 1-2 R⁵; or a phenyl or 5- or 6-membered heteroaromatic ring, each ring optionally substituted with 1 to 3 substituents independently selected from R⁶;
R³ is halogen;
W is H or NH₂; and
R⁴ is H or halogen.

### Embodiment B

The method of Embodiment A wherein
R¹ is C₃-C₅ cycloalkyl optionally substituted with 1-2 R⁵, or phenyl or 5- or 6-membered heteroaromatic ring, each ring optionally substituted with 1 to 3 substituents independently selected from R⁶;
X is N;
each R⁵ is independently halogen, C₁-C₆ alkyl or C₁-C₆ haloalkyl; and
each R⁶ is independently halogen, cyano, nitro, C₁-C₄ alkyl, C₁-C₄ haloalkyl or C₁-C₄ alkoxy.

### Embodiment C

The method of Embodiment B wherein
R¹ is cyclopropyl or phenyl substituted with a halogen, methyl or methoxy radical in the para position and optionally with 1-2 radicals selected from halogen and methyl in other positions.

### Embodiment D

The method of Embodiment B wherein
R² is CO₂H or a salt thereof, or R² is CO₂R⁵¹; and
R⁵¹ is benzyl, C₁-C₁₀ alkyl, C₂-C₁₀ alkoxyalkyl, C₃-C₁₀ alkoxyalkoxyalkyl or C₂-C₁₀ hydroxyalkyl.

### Embodiment E

The method of Embodiment D wherein
R¹ is cyclopropyl, 4-Br-phenyl or 4-C₁-phenyl;
R² is CO₂H or a salt thereof, or R² is CO₂R⁵¹; and
R⁵¹ is C₁-C₂ alkyl.

### Embodiment F

The method of Embodiment D wherein
R¹ is cyclopropyl, 4-Br-phenyl or 4-C₁-phenyl;
R² is CO₂R⁵¹; and
R⁵¹ is C₅-C₈ alkyl, C₅-C₈ alkoxyalkyl, C₅-C₈ alkoxyalkoxyalkyl or C₅-C₈ hydroxyalkyl.

Specific Embodiments include the method as set forth in the Summary of the Invention wherein the compound of Formula 1 is selected from the group consisting of:
methyl 6-amino-5-bromo-2-cyclopropyl-4-pyrimidinecarboxylate (Compound 1),
ethyl 6-amino-5-bromo-2-cyclopropyl-4-pyrimidinecarboxylate (Compound 2),
6-amino-5-bromo-2-cyclopropyl-4-pyrimidinecarboxylic acid monosodium salt (Compound 3),
methyl 6-amino-5-chloro-2-cyclopropyl-4-pyrimidinecarboxylate (Compound 4),
6-amino-5-chloro-2-cyclopropyl-4-pyrimidinecarboxylic acid monosodium salt (Compound 5),
ethyl 6-amino-5-chloro-2-cyclopropyl-4-pyrimidinecarboxylate (Compound 6),
methyl 6-amino-5-chloro-2-(4-chlorophenyl)-4-pyrimidinecarboxylate (Compound 7),
ethyl 6-amino-5-chloro-2-(4-chlorophenyl)-4-pyrimidinecarboxylate (Compound 8),
6-amino-5-chloro-2-(4-chlorophenyl)-4-pyrimidinecarboxylic acid (Compound 9),
ethyl 6-amino-2-(4-bromophenyl)-5-chloro-4-pyrimidinecarboxylate (Compound 10),
methyl 6-amino-2-(4-bromophenyl)-5-chloro-4-pyrimidinecarboxylate (Compound 11),
6-amino-2-(4-bromophenyl)-5-chloro-4-pyrimidinecarboxylic acid (Compound 12),
6-amino-5-bromo-2-cyclopropyl-4-pyrimidinecarboxylic acid (Compound 13),
6-amino-5-chloro-2-cyclopropyl-4-pyrimidinecarboxylic acid (Compound 14),
phenylmethyl 6-amino-5-bromo-2-cyclopropyl-4-pyrimidinecarboxylate (Compound 15),
phenylmethyl 6-amino-5-chloro-2-cyclopropyl-4-pyrimidinecarboxylate (Compound 16),
1-methylethyl 6-amino-5-chloro-2-cyclopropyl-4-pyrimidinecarboxylate (Compound 17),
butyl 6-amino-5-chloro-2-cyclopropyl-4-pyrimidinecarboxylate (Compound 18),
3-hydroxypropyl 6-amino-5-chloro-2-cyclopropyl-4-pyrimidinecarboxylate (Compound 19),
propyl 6-amino-5-chloro-2-cyclopropyl-4-pyrimidinecarboxylate (Compound 20),
1-methylheptyl 6-amino-5-chloro-2-cyclopropyl-4-pyrimidinecarboxylate (Compound 21),
2-(2-methoxyethoxy)ethyl 6-amino-5-chloro-2-cyclopropyl-4-pyrimidinecarboxylate (Compound 22),
octyl 6-amino-5-chloro-2-cyclopropyl-4-pyrimidinecarboxylate (Compound 23),
2-butoxyethyl 6-amino-5-chloro-2-cyclopropyl-4-pyrimidinecarboxylate (Compound 24),
2-ethylhexyl 6-amino-5-chloro-2-cyclopropyl-4-pyrimidinecarboxylate (Compound 25), and
2-butoxy-1-methylethyl 6-amino-5-chloro-2-cyclopropyl-4-pyrimidinecarboxylate (Compound 26).

Also Specific Embodiments include the method wherein the compound of Formula 1 is selected from the group consisting of:
[(3,5,6-trichloro-2-pyridinyl)oxy]acetic acid (Compound 27),
3,6-dichloro-2-pyridinecarboxylic acid (Compound 28),
4-amino-3,6-dichloro-2-pyridinecarboxylic acid (Compound 29), and
4-amino-3,5,6-trichloro-2-pyridinecarboxylic acid (Compound 30).

Compounds of Formula 1 can be prepared by one or more of the methods and variations thereof as described in PCT Patent Publication WO 2005/063721, U.S. Patent Publication 2004/0198608 or U.S. Pat. No. 6,784,137, which are hereby incorporated by reference in their entirety. For example, compounds 2, 4, 8, 9 and 14 as identified in Table 1 can be prepared by the methods described in Example 1 (page 27), Example 3 (page 31), Example 5 (page 33), Example 4 (page 32), and Example 2 (page 29), respectively, of PCT Publication WO 2005/063721. Compound 15 is commercially available from Agripha or Dow AgroSciences. Compound 16 is commercially available from Agripha. Compound 29 can be prepared by the method described in Example 1 (Column number 9) of U.S. Pat. No. 6,297,197, which is hereby incorporated by reference in its entirety. Compound 30 is commercially available from Dow AgroSciences.

The harvest aid compounds acting as a defoliant or desiccant have been described in published patents and scientific journal papers. Many of these compounds are commercially available as active ingredients in harvest aid products. These compounds are described in compendia such as The Pesticide Manual, 13th edition, C. D. S. Thomlin (Ed.), British Crop Protection Council, Surrey, UK, 2003.

The present invention is used advantageously to improve harvestability of cultivated plants, which results in a higher economic (crop) yield. The efficacy for improving harvestability of cultivated plants depends on, among other things, the amount of the compound of Formula 1 applied per hectare (or acre), the treatment time, and the type of plant to which it is applied. When the compound of Formula 1 is mixed together with one or more defoliants or desiccants (i.e. the component acting as a defoliant or desiccant), the efficacy for improving harvestability of cultivated plants also depends on, among other things, the amount of the combination of a compound of Formula 1 and the component acting as a defoliant or desiccant, applied per hectare (or acre), and the relative proportions of the component acting as a defoliant or desiccant to the compound of Formula 1. To achieve the desired harvest aid effects of regrowth inhibition, defoliation or desiccation, as well as boll opening, it is typical to use multiple products in mixture or sequence. The principal contribution to harvestability from applying a compound of Formula 1 alone or in combination or in sequence with defoliants, desiccants or boll openers is prevention of basal as well as terminal regrowth. Application of a defoliant, desiccant or boll opener in combination or in sequence with a compound of Formula 1 typically does not reduce the effectiveness of the compound of Formula 1 in preventing regrowth. The effect of mixing a compound of Formula 1 with defoliants, desiccants or boll openers on defoliation, desiccation or boll opening may depend on factors such as application timing, and in certain situations an enhancement of defoliation, desiccation or boll opening may be apparent. Furthermore, the defoliation, desiccation and/or regrowth inhibition effects exhibited by the combination of a compound of Formula 1 and at least one compound acting as a defoliant or desiccant, may be significantly better than those observed when a compound of Formula 1 is employed alone.

The present invention is useful for regrowth inhibition on crop plants whose harvestability is improved by defoliation and/or desiccation. These crops include but are not limited to, cotton, tuberous crops such as potato, beets and the like, citrus tree, tomato, pepper, tobacco, peanut and sugarcane. Cotton is an example of a crop where the use of the regrowth inhibitors according to the present invention is particularly valuable.

By the procedures described in pages 22-33 of PCT Patent Publication WO 2005/063721, pages 3-4 and pages 6-8 of U.S. Patent Publication 2004/0198608, and column number 5-7 and column number 11-31 of U.S. Pat. No. 6,784,137 together with methods known in the art, the following compounds of Tables 1 to 3 can be prepared. The following abbreviations are used in the Tables which follow: t means tertiary, i means iso, Me means methyl, Et means ethyl, Pr means propyl (i.e. n-propyl), i-Pr means isopropyl, c-Pr means cyclopropyl, Bu means butyl (i.e. n-butyl), t-Bu means tert-butyl, “.” means negative formal charge, and “+” means positive formal charge. The compound numbers (Compd. No.) of Tables 1 to 3 refer to compounds listed as Specific Embodiments in the Details of the Invention.

TABLE 1

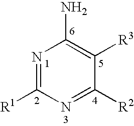

| | | |
|---|---|---|
| Compd | | |
| No. | R³ | R² |

R¹ is c-Pr.

| | | |
|---|---|---|
| | F | CO₂H |
| | F | CO₂Me |
| | F | CO₂Et |
| | F | CO₂Pr |
| | F | CO₂iPr |
| | F | CO₂t-Bu |
| | F | CO₂Bu |
| | F | CO₂(CH₂)₃OH |
| | F | CO₂CHMe(CH₂)₅CH₃ |
| | F | CO₂(CH₂)₂O(CH₂)₂OCH₃ |
| | F | CO₂CH₂(CH₂)₆CH₃ |
| | F | CO₂(CH₂)₂O(CH₂)₃CH₃ |
| | F | CO₂CH₂CHEt(CH₂)₃CH₃ |
| | F | CO₂CHMeCH₂O(CH₂)₃CH₃ |
| | F | CH₂OH |
| | F | CH₂OMe |
| | F | CHO |
| | F | C(═O)NH₂ |
| | F | CO₂CH₂Ph |
| | F | CO₂Ph |
| | F | C(O)O, H₃N⁺Me |
| | F | C(O)O, H₃N⁺i-Pr |
| | F | OCH₂CO₂H |
| | F | C(O)O, HN⁺(Et)₃ |
| | F | C(O)O, N⁺(Me)₄ |
| | F | C(O)O, Na⁺ |
| 14 | Cl | CO₂H |
| 4 | Cl | CO₂Me |
| 6 | Cl | CO₂Et |
| 20 | Cl | CO₂Pr |
| 17 | Cl | CO₂iPr |
| | Cl | CO₂t-Bu |
| 18 | Cl | CO₂Bu |
| 19 | Cl | CO₂(CH₂)₃OH |
| 21 | Cl | CO₂CHMe(CH₂)₅CH₃ |
| 22 | Cl | CO₂(CH₂)₂O(CH₂)₂OCH₃ |
| 23 | Cl | CO₂CH₂(CH₂)₆CH₃ |
| 24 | Cl | CO₂(CH₂)₂O(CH₂)₃CH₃ |
| 25 | Cl | CO₂CH₂CHEt(CH₂)₃CH₃ |
| 26 | Cl | CO₂CHMeCH₂O(CH₂)₃CH₃ |
| | Cl | CH₂OH |
| | Cl | CH₂OMe |
| | Cl | CHO |
| | Cl | C(═O)NH₂ |
| 16 | Cl | CO₂CH₂Ph |
| | Cl | CO₂Ph |
| | Cl | C(O)O, H₃N⁺Me |
| | Cl | C(O)O, H₃N⁺i-Pr |
| | Cl | OCH₂CO₂H |
| | Cl | C(O)O, HN⁺(Et)₃ |
| | Cl | C(O)O, N⁺(Me)₄ |
| 5 | Cl | C(O)O, Na⁺ |
| 13 | Br | CO₂H |
| 1 | Br | CO₂Me |
| 2 | Br | CO₂Et |
| | Br | CO₂Pr |
| | Br | CO₂iPr |
| | Br | CO₂t-Bu |
| | Br | CO₂Bu |
| | Br | CO₂(CH₂)₃OH |
| | Br | CO₂CHMe(CH₂)₅CH₃ |
| | Br | CO₂(CH₂)₂O(CH₂)₂OCH₃ |
| | Br | CO₂CH₂(CH₂)₆CH₃ |
| | Br | CO₂(CH₂)₂O(CH₂)₃CH₃ |
| | Br | CO₂CH₂CHEt(CH₂)₃CH₃ |
| | Br | CO₂CHMeCH₂O(CH₂)₃CH₃ |
| | Br | CH₂OH |
| | Br | CH₂OMe |
| | Br | CHO |
| | Br | C(═O)NH₂ |
| 15 | Br | CO₂CH₂Ph |
| | Br | CO₂Ph |
| | Br | C(O)O, H₃N⁺Me |
| | Br | C(O)O, H₃N⁺i-Pr |
| | Br | OCH₂CO₂H |
| | Br | C(O)O, HN⁺(Et)₃ |
| | Br | C(O)O, N⁺(Me)₄ |
| 3 | Br | C(O)O, Na⁺ |
| | I | CO₂H |
| | I | CO₂Me |
| | I | CO₂Et |
| | I | CO₂Pr |
| | I | CO₂iPr |
| | I | CO₂t-Bu |
| | I | CO₂Bu |
| | I | CO₂(CH₂)₃OH |
| | I | CO₂CHMe(CH₂)₅CH₃ |
| | I | CO₂(CH₂)₂O(CH₂)₂OCH₃ |
| | I | CO₂CH₂(CH₂)₆CH₃ |
| | I | CO₂(CH₂)₂O(CH₂)₃CH₃ |
| | I | CO₂CH₂CHEt(CH₂)₃CH₃ |
| | I | CO₂CHMeCH₂O(CH₂)₃CH₃ |
| | I | CH₂OH |
| | I | CH₂OMe |
| | I | CHO |
| | I | C(═O)NH₂ |
| | I | CO₂CH₂Ph |
| | I | CO₂Ph |
| | I | C(O)O, H₃N⁺Me |
| | I | C(O)O, H₃N⁺i-Pr |
| | I | OCH₂CO₂H |
| | I | C(O)O, HN⁺(Et)₃ |
| | I | C(O)O, N⁺(Me)₄ |
| | I | C(O)O, Na⁺ |

R¹ is 4-Cl-Ph.

| | | |
|---|---|---|
| | F | CO₂H |
| | F | CO₂Me |
| | F | CO₂Et |
| | F | CO₂Pr |
| | F | CO₂iPr |
| | F | CO₂t-Bu |
| | F | CO₂Bu |
| | F | CO₂(CH₂)₃OH |
| | F | CO₂CHMe(CH₂)₅CH₃ |
| | F | CO₂(CH₂)₂O(CH₂)₂OCH₃ |
| | F | CO₂CH₂(CH₂)₆CH₃ |
| | F | CO₂(CH₂)₂O(CH₂)₃CH₃ |
| | F | CO₂CH₂CHEt(CH₂)₃CH₃ |
| | F | CO₂CHMeCH₂O(CH₂)₃CH₃ |
| | F | CH₂OH |
| | F | CH₂OMe |
| | F | CHO |
| | F | C(═O)NH₂ |
| | F | CO₂CH₂Ph |
| | F | CO₂Ph |
| | F | C(O)O, H₃N⁺Me |
| | F | C(O)O, H₃N⁺i-Pr |
| | F | OCH₂CO₂H |
| | F | C(O)O, HN⁺(Et)₃ |
| | F | C(O)O, N⁺(Me)₄ |
| | F | C(O)O, Na⁺ |
| 9 | Cl | CO₂H |
| 7 | Cl | CO₂Me |
| 8 | Cl | CO₂Et |
| | Cl | CO₂Pr |
| | Cl | CO₂iPr |
| | Cl | CO₂t-Bu |
| | Cl | CO₂Bu |
| | Cl | CO₂(CH₂)₃OH |
| | Cl | CO₂CHMe(CH₂)₅CH₃ |
| | Cl | CO₂(CH₂)₂O(CH₂)₂OCH₃ |
| | Cl | CO₂CH₂(CH₂)₆CH₃ |
| | Cl | CO₂(CH₂)₂O(CH₂)₃CH₃ |
| | Cl | CO₂CH₂CHEt(CH₂)₃CH₃ |
| | Cl | CO₂CHMeCH₂O(CH₂)₃CH₃ |
| | Cl | CH₂OH |
| | Cl | CH₂OMe |
| | Cl | CHO |
| | Cl | C(═O)NH₂ |
| | Cl | CO₂CH₂Ph |
| | Cl | CO₂Ph |
| | Cl | C(O)O, H₃N⁺Me |
| | Cl | C(O)O, H₃N⁺i-Pr |
| | Cl | OCH₂CO₂H |
| | Cl | C(O)O, HN⁺(Et)₃ |
| | Cl | C(O)O, N⁺(Me)₄ |
| | Cl | C(O)O, Na⁺ |
| | Br | CO₂H |
| | Br | CO₂Me |
| | Br | CO₂Et |
| | Br | CO₂Pr |
| | Br | CO₂iPr |
| | Br | CO₂t-Bu |
| | Br | CO₂Bu |
| | Br | CO₂(CH₂)₃OH |
| | Br | CO₂CHMe(CH₂)₅CH₃ |
| | Br | CO₂(CH₂)₂O(CH₂)₂OCH₃ |
| | Br | CO₂CH₂(CH₂)₆CH₃ |
| | Br | CO₂(CH₂)₂O(CH₂)₃CH₃ |
| | Br | CO₂CH₂CHEt(CH₂)₃CH₃ |
| | Br | CO₂CHMeCH₂O(CH₂)₃CH₃ |
| | Br | CH₂OH |
| | Br | CH₂OMe |
| | Br | CHO |
| | Br | C(═O)NH₂ |
| | Br | CO₂CH₂Ph |
| | Br | CO₂Ph |
| | Br | C(O)O, H₃N⁺Me |
| | Br | C(O)O, H₃N⁺i-Pr |
| | Br | OCH₂CO₂H |
| | Br | C(O)O, HN⁺(Et)₃ |
| | Br | C(O)O, N⁺(Me)₄ |
| | Br | C(O)O, Na⁺ |
| | I | CO₂H |
| | I | CO₂Me |
| | I | CO₂Et |
| | I | CO₂Pr |
| | I | CO₂iPr |
| | I | CO₂t-Bu |
| | I | CO₂Bu |
| | I | CO₂(CH₂)₃OH |
| | I | CO₂CHMe(CH₂)₅CH₃ |
| | I | CO₂(CH₂)₂O(CH₂)₂OCH₃ |
| | I | CO₂CH₂(CH₂)₆CH₃ |
| | I | CO₂(CH₂)₂O(CH₂)₃CH₃ |
| | I | CO₂CH₂CHEt(CH₂)₃CH₃ |
| | I | CO₂CHMeCH₂O(CH₂)₃CH₃ |
| | I | CH₂OH |
| | I | CH₂OMe |
| | I | CHO |
| | I | C(═O)NH₂ |
| | I | CO₂CH₂Ph |
| | I | CO₂Ph |
| | I | C(O)O, H₃N⁺Me |
| | I | C(O)O, H₃N⁺i-Pr |
| | I | OCH₂CO₂H |
| | I | C(O)O, HN⁺(Et)₃ |
| | I | C(O)O, N⁺(Me)₄ |
| | I | C(O)O, Na⁺ |

R¹ is 4-Br-Ph.

| | | |
|---|---|---|
| | F | CO₂H |
| | F | CO₂Me |
| | F | CO₂Et |
| | F | CO₂Pr |
| | F | CO₂iPr |
| | F | CO₂t-Bu |
| | F | CO₂Bu |
| | F | CO₂(CH₂)₃OH |
| | F | CO₂CHMe(CH₂)₅CH₃ |
| | F | CO₂(CH₂)₂O(CH₂)₂OCH₃ |
| | F | CO₂CH₂(CH₂)₆CH₃ |
| | F | CO₂(CH₂)₂O(CH₂)₃CH₃ |
| | F | CO₂CH₂CHEt(CH₂)₃CH₃ |
| | F | CO₂CHMeCH₂O(CH₂)₃CH₃ |
| | F | CH₂OH |
| | F | CH₂OMe |
| | F | CHO |
| | F | C(═O)NH₂ |
| | F | CO₂CH₂Ph |
| | F | CO₂Ph |
| | F | C(O)O, H₃N⁺Me |
| | F | C(O)O, H₃N⁺i-Pr |
| | F | OCH₂CO₂H |
| | F | C(O)O, HN⁺(Et)₃ |
| | F | C(O)O, N⁺(Me)₄ |
| | F | C(O)O, Na⁺ |
| 12 | Cl | CO₂H |
| 11 | Cl | CO₂Me |
| 10 | Cl | CO₂Et |
| | Cl | CO₂Pr |
| | Cl | CO₂iPr |
| | Cl | CO₂t-Bu |
| | Cl | CO₂Bu |
| | Cl | CO₂(CH₂)₃OH |
| | Cl | CO₂CHMe(CH₂)₅CH₃ |
| | Cl | CO₂(CH₂)₂O(CH₂)₂OCH₃ |
| | Cl | CO₂CH₂(CH₂)₆CH₃ |
| | Cl | CO₂(CH₂)₂O(CH₂)₃CH₃ |
| | Cl | CO₂CH₂CHEt(CH₂)₃CH₃ |
| | Cl | CO₂CHMeCH₂O(CH₂)₃CH₃ |
| | Cl | CH₂OH |
| | Cl | CH₂OMe |
| | Cl | CHO |
| | Cl | C(═O)NH₂ |
| | Cl | CO₂CH₂Ph |
| | Cl | CO₂Ph |
| | Cl | C(O)O, H₃N⁺Me |
| | Cl | C(O)O, H₃N⁺i-Pr |
| | Cl | OCH₂CO₂H |
| | Cl | C(O)O, HN⁺(Et)₃ |
| | Cl | C(O)O, N⁺(Me)₄ |
| | Cl | C(O)O, Na⁺ |
| | Br | CO₂H |
| | Br | CO₂Me |
| | Br | CO₂Et |
| | Br | CO₂Pr |
| | Br | CO₂iPr |
| | Br | CO₂t-Bu |
| | Br | CO₂Bu |
| | Br | CO₂(CH₂)₃OH |
| | Br | CO₂CHMe(CH₂)₅CH₃ |
| | Br | CO₂(CH₂)₂O(CH₂)₂OCH₃ |
| | Br | CO₂CH₂(CH₂)₆CH₃ |
| | Br | CO₂(CH₂)₂O(CH₂)₃CH₃ |
| | Br | CO₂CH₂CHEt(CH₂)₃CH₃ |
| | Br | CO₂CHMeCH₂O(CH₂)₃CH₃ |
| | Br | CH₂OH |
| | Br | CH₂OMe |
| | Br | CHO |
| | Br | C(═O)NH₂ |
| | Br | CO₂CH₂Ph |
| | Br | CO₂Ph |
| | Br | C(O)O, H₃N⁺Me |
| | Br | C(O)O, H₃N⁺i-Pr |
| | Br | OCH₂CO₂H |
| | Br | C(O)O, HN⁺(Et)₃ |
| | Br | C(O)O, N⁺(Me)₄ |
| | Br | C(O)O, Na⁺ |
| | I | CO₂H |
| | I | CO₂Me |
| | I | CO₂Et |
| | I | CO₂Pr |
| | I | CO₂iPr |
| | I | CO₂t-Bu |
| | I | CO₂Bu |
| | I | CO₂(CH₂)₃OH |
| | I | CO₂CHMe(CH₂)₅CH₃ |
| | I | CO₂(CH₂)₂O(CH₂)₂OCH₃ |
| | I | CO₂CH₂(CH₂)₆CH₃ |
| | I | CO₂(CH₂)₂O(CH₂)₃CH₃ |
| | I | CO₂CH₂CHEt(CH₂)₃CH₃ |
| | I | CO₂CHMeCH₂O(CH₂)₃CH₃ |
| | I | CH₂OH |
| | I | CH₂OMe |
| | I | CHO |
| | I | C(═O)NH₂ |
| | I | CO₂CH₂Ph |
| | I | CO₂Ph |
| | I | C(O)O, H₃N⁺Me |
| | I | C(O)O, H₃N⁺i-Pr |
| | I | OCH₂CO₂H |
| | I | C(O)O, HN⁺(Et)₃ |
| | I | C(O)O, N⁺(Me)₄ |
| | I | C(O)O, Na⁺ |

TABLE 2

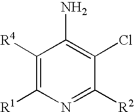

| Compd | | | |
|---|---|---|---|
| No. | R¹ | R² | R⁴ |
| | cyclopropyl | CO₂H | H |
| | cyclopropyl | CO₂Me | H |
| | cyclopropyl | CO₂Et | H |
| | cyclopropyl | CO₂Pr | H |
| | cyclopropyl | CO₂iPr | H |
| | cyclopropyl | C(O)O, H₃N⁺Me | H |
| | cyclopropyl | C(O)O, HN⁺(Me)₃ | H |
| | cyclopropyl | C(O)O, N⁺(Me)₄ | H |
| | cyclopropyl | C(O)O, Na⁺ | H |
| | cyclopropyl | OCH₂CO₂H | H |
| | cyclopropyl | CO₂H | F |
| | cyclopropyl | CO₂Me | F |
| | cyclopropyl | CO₂Et | F |
| | cyclopropyl | CO₂Pr | F |
| | cyclopropyl | CO₂iPr | F |
| | cyclopropyl | C(O)O, H₃N⁺Me | F |
| | cyclopropyl | C(O)O, HN⁺(Me)₃ | F |
| | cyclopropyl | C(O)O, N⁺(Me)₄ | F |
| | cyclopropyl | C(O)O, Na⁺ | F |
| | cyclopropyl | OCH₂CO₂H | F |
| | cyclopropyl | CO₂H | Cl |
| | cyclopropyl | CO₂Me | Cl |
| | cyclopropyl | CO₂Et | Cl |
| | cyclopropyl | CO₂Pr | Cl |
| | cyclopropyl | CO₂iPr | Cl |
| | cyclopropyl | C(O)O, H₃N⁺Me | Cl |
| | cyclopropyl | C(O)O, HN⁺(Me)₃ | Cl |
| | cyclopropyl | C(O)O, N⁺(Me)₄ | Cl |
| | cyclopropyl | C(O)O, Na⁺ | Cl |
| | cyclopropyl | OCH₂CO₂H | Cl |
| | 4-Cl-Ph | CO₂H | H |
| | 4-Cl-Ph | CO₂Me | H |
| | 4-Cl-Ph | CO₂Et | H |
| | 4-Cl-Ph | CO₂Pr | H |
| | 4-Cl-Ph | CO₂iPr | H |
| | 4-Cl-Ph | C(O)O, H₃N⁺Me | H |
| | 4-Cl-Ph | C(O)O, HN⁺(Me)₃ | H |
| | 4-Cl-Ph | C(O)O, N⁺(Me)₄ | H |
| | 4-Cl-Ph | C(O)O, Na⁺ | H |
| | 4-Cl-Ph | OCH₂CO₂H | H |
| | 4-Cl-Ph | CO₂H | F |
| | 4-Cl-Ph | CO₂Me | F |
| | 4-Cl-Ph | CO₂Et | F |
| | 4-Cl-Ph | CO₂Pr | F |
| | 4-Cl-Ph | CO₂iPr | F |
| | 4-Cl-Ph | C(O)O, H₃N⁺Me | F |
| | 4-Cl-Ph | C(O)O, HN⁺(Me)₃ | F |
| | 4-Cl-Ph | C(O)O, N⁺(Me)₄ | F |
| | 4-Cl-Ph | C(O)O, Na⁺ | F |
| | 4-Cl-Ph | OCH₂CO₂H | F |
| | 4-Cl-Ph | CO₂H | Cl |
| | 4-Cl-Ph | CO₂Me | Cl |
| | 4-Cl-Ph | CO₂Et | Cl |
| | 4-Cl-Ph | CO₂Pr | Cl |
| | 4-Cl-Ph | CO₂iPr | Cl |
| | 4-Cl-Ph | C(O)O, H₃N⁺Me | Cl |
| | 4-Cl-Ph | C(O)O, HN⁺(Me)₃ | Cl |
| | 4-Cl-Ph | C(O)O, N⁺(Me)₄ | Cl |
| | 4-Cl-Ph | C(O)O, Na⁺ | Cl |
| | 4-Cl-Ph | OCH₂CO₂H | Cl |
| | 2-thienyl | CO₂H | H |
| | 2-thienyl | CO₂Me | H |
| | 2-thienyl | CO₂Et | H |
| | 2-thienyl | CO₂Pr | H |
| | 2-thienyl | CO₂iPr | H |
| | 2-thienyl | C(O)O, H₃N⁺Me | H |
| | 2-thienyl | C(O)O, HN⁺(Me)₃ | H |
| | 2-thienyl | C(O)O, N⁺(Me)₄ | H |
| | 2-thienyl | C(O)O, Na⁺ | H |
| | 2-thienyl | OCH₂CO₂H | H |
| | 2-thienyl | CO₂H | F |
| | 2-thienyl | CO₂Me | F |
| | 2-thienyl | CO₂Et | F |
| | 2-thienyl | CO₂Pr | F |
| | 2-thienyl | CO₂iPr | F |
| | 2-thienyl | C(O)O, H₃N⁺Me | F |
| | 2-thienyl | C(O)O, HN⁺(Me)₃ | F |
| | 2-thienyl | C(O)O, N⁺(Me)₄ | F |
| | 2-thienyl | C(O)O, Na⁺ | F |
| | 2-thienyl | OCH₂CO₂H | F |
| | 2-thienyl | CO₂H | Cl |
| | 2-thienyl | CO₂Me | Cl |
| | 2-thienyl | CO₂Et | Cl |
| | 2-thienyl | CO₂Pr | Cl |
| | 2-thienyl | CO₂iPr | Cl |
| | 2-thienyl | C(O)O, H₃N⁺Me | Cl |
| | 2-thienyl | C(O)O, HN⁺(Me)₃ | Cl |
| | 2-thienyl | C(O)O, N⁺(Me)₄ | Cl |
| | 2-thienyl | C(O)O, Na⁺ | Cl |
| | 2-thienyl | OCH₂CO₂H | Cl |
| | Me | CO₂H | H |
| | Me | CO₂Me | H |
| | Me | CO₂Et | H |
| | Me | CO₂Pr | H |
| | Me | CO₂iPr | H |
| | Me | C(O)O, H₃N⁺Me | H |
| | Me | C(O)O, HN⁺(Me)₃ | H |
| | Me | C(O)O, N⁺(Me)₄ | H |
| | Me | C(O)O, Na⁺ | H |
| | Me | OCH₂CO₂H | H |
| | Me | CO₂H | F |
| | Me | CO₂Me | F |
| | Me | CO₂Et | F |
| | Me | CO₂Pr | F |
| | Me | CO₂iPr | F |
| | Me | C(O)O, H₃N⁺Me | F |
| | Me | C(O)O, HN⁺(Me)₃ | F |
| | Me | C(O)O, N⁺(Me)₄ | F |
| | Me | C(O)O, Na⁺ | F |
| | Me | OCH₂CO₂H | F |
| | Me | CO₂H | Cl |
| | Me | CO₂Me | Cl |
| | Me | CO₂Et | Cl |
| | Me | CO₂Pr | Cl |
| | Me | CO₂iPr | Cl |
| | Me | C(O)O, H₃N⁺Me | Cl |
| | Me | C(O)O, HN⁺(Me)₃ | Cl |
| | Me | C(O)O, N⁺(Me)₄ | Cl |
| | Me | C(O)O, Na⁺ | Cl |
| | Me | OCH₂CO₂H | Cl |
| | Et | CO₂H | H |
| | Et | CO₂Me | H |
| | Et | CO₂Et | H |
| | Et | CO₂Pr | H |
| | Et | CO₂iPr | H |
| | Et | C(O)O, H₃N⁺Me | H |
| | Et | C(O)O, HN⁺(Me)₃ | H |
| | Et | C(O)O, N⁺(Me)₄ | H |
| | Et | C(O)O, Na⁺ | H |
| | Et | OCH₂CO₂H | H |
| | Et | CO₂H | F |
| | Et | CO₂Me | F |
| | Et | CO₂Et | F |
| | Et | CO₂Pr | F |
| | Et | CO₂iPr | F |
| | Et | C(O)O, H₃N⁺Me | F |
| | Et | C(O)O, HN⁺(Me)₃ | F |
| | Et | C(O)O, N⁺(Me)₄ | F |
| | Et | C(O)O, Na⁺ | F |
| | Et | OCH₂CO₂H | F |
| | Et | CO₂H | Cl |
| | Et | CO₂Me | Cl |
| | Et | CO₂Et | Cl |
| | Et | CO₂Pr | Cl |
| | Et | CO₂iPr | Cl |
| | Et | C(O)O, H₃N⁺Me | Cl |
| | Et | C(O)O, HN⁺(Me)₃ | Cl |
| | Et | C(O)O, N⁺(Me)₄ | Cl |
| | Et | C(O)O, Na⁺ | Cl |
| | Et | OCH₂CO₂H | Cl |
| 29 | Cl | CO₂H | H |
| | Cl | CO₂Me | H |
| | Cl | CO₂Et | H |
| | Cl | CO₂Pr | H |
| | Cl | CO₂iPr | H |
| | Cl | C(O)O, H₃N⁺Me | H |
| | Cl | C(O)O, HN⁺(Me)₃ | H |
| | Cl | C(O)O, N⁺(Me)₄ | H |
| | Cl | C(O)O, Na⁺ | H |
| | Cl | OCH₂CO₂H | H |
| | Cl | CO₂H | F |
| | Cl | CO₂Me | F |
| | Cl | CO₂Et | F |
| | Cl | CO₂Pr | F |
| | Cl | CO₂iPr | F |
| | Cl | C(O)O, H₃N⁺Me | F |
| | Cl | C(O)O, HN⁺(Me)₃ | F |
| | Cl | C(O)O, N⁺(Me)₄ | F |
| | Cl | C(O)O, Na⁺ | F |
| | Cl | OCH₂CO₂H | F |
| 30 | Cl | CO₂H | Cl |
| | Cl | CO₂Me | Cl |
| | Cl | CO₂Et | Cl |
| | Cl | CO₂Pr | Cl |
| | Cl | CO₂iPr | Cl |
| | Cl | C(O)O, H₃N⁺Me | Cl |
| | Cl | C(O)O, HN⁺(Me)₃ | Cl |
| | Cl | C(O)O, N⁺(Me)₄ | Cl |
| | Cl | C(O)O, Na⁺ | Cl |
| | Cl | OCH₂CO₂H | Cl |

TABLE 3

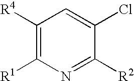

| Compd | | | |
|---|---|---|---|
| No. | R¹ | R² | R⁴ |
| | 4-Cl-Ph | CO₂H | H |
| | 4-Cl-Ph | CO₂Me | H |
| | 4-Cl-Ph | CO₂Et | H |
| | 4-Cl-Ph | CO₂Pr | H |
| | 4-Cl-Ph | CO₂iPr | H |
| | 4-Cl-Ph | C(O)O, H₃N⁺Me | H |
| | 4-Cl-Ph | C(O)O, HN⁺(Me)₃ | H |
| | 4-Cl-Ph | C(O)O, N⁺(Me)₄ | H |
| | 4-Cl-Ph | C(O)O, Na⁺ | H |
| | 4-Cl-Ph | OCH₂CO₂H | H |
| | 4-Cl-Ph | CO₂H | F |
| | 4-Cl-Ph | CO₂Me | F |
| | 4-Cl-Ph | CO₂Et | F |
| | 4-Cl-Ph | CO₂Pr | F |
| | 4-Cl-Ph | CO₂iPr | F |
| | 4-Cl-Ph | C(O)O, H₃N⁺Me | F |
| | 4-Cl-Ph | C(O)O, HN⁺(Me)₃ | F |
| | 4-Cl-Ph | C(O)O, N⁺(Me)₄ | F |
| | 4-Cl-Ph | C(O)O, Na⁺ | F |
| | 4-Cl-Ph | OCH₂CO₂H | F |
| | 4-Cl-Ph | CO₂H | Cl |
| | 4-Cl-Ph | CO₂Me | Cl |
| | 4-Cl-Ph | CO₂Et | Cl |
| | 4-Cl-Ph | CO₂Pr | Cl |
| | 4-Cl-Ph | CO₂iPr | Cl |
| | 4-Cl-Ph | C(O)O, H₃N⁺Me | Cl |
| | 4-Cl-Ph | C(O)O, HN⁺(Me)₃ | Cl |
| | 4-Cl-Ph | C(O)O, N⁺(Me)₄ | Cl |
| | 4-Cl-Ph | C(O)O, Na⁺ | Cl |
| | 4-Cl-Ph | OCH₂CO₂H | Cl |
| | 2-thiazolyl | CO₂H | H |
| | 2-thiazolyl | CO₂Me | H |
| | 2-thiazolyl | CO₂Et | H |
| | 2-thiazolyl | CO₂Pr | H |
| | 2-thiazolyl | CO₂iPr | H |
| | 2-thiazolyl | C(O)O, H₃N⁺Me | H |
| | 2-thiazolyl | C(O)O, HN⁺(Me)₃ | H |
| | 2-thiazolyl | C(O)O, N⁺(Me)₄ | H |
| | 2-thiazolyl | C(O)O, Na⁺ | H |
| | 2-thiazolyl | OCH₂CO₂H | H |
| | 2-thiazolyl | CO₂H | F |
| | 2-thiazolyl | CO₂Me | F |
| | 2-thiazolyl | CO₂Et | F |
| | 2-thiazolyl | CO₂Pr | F |
| | 2-thiazolyl | CO₂iPr | F |
| | 2-thiazolyl | C(O)O, H₃N⁺Me | F |
| | 2-thiazolyl | C(O)O, HN⁺(Me)₃ | F |
| | 2-thiazolyl | C(O)O, N⁺(Me)₄ | F |
| | 2-thiazolyl | C(O)O, Na⁺ | F |
| | 2-thiazolyl | OCH₂CO₂H | F |
| | 2-thiazolyl | CO₂H | Cl |
| | 2-thiazolyl | CO₂Me | Cl |
| | 2-thiazolyl | CO₂Et | Cl |
| | 2-thiazolyl | CO₂Pr | Cl |
| | 2-thiazolyl | CO₂iPr | Cl |
| | 2-thiazolyl | C(O)O, H₃N⁺Me | Cl |
| | 2-thiazolyl | C(O)O, HN⁺(Me)₃ | Cl |
| | 2-thiazolyl | C(O)O, N⁺(Me)₄ | Cl |
| | 2-thiazolyl | C(O)O, Na⁺ | Cl |
| | 2-thiazolyl | OCH₂CO₂H | Cl |
| | Me | CO₂H | H |
| | Me | CO₂Me | H |
| | Me | CO₂Et | H |
| | Me | CO₂Pr | H |
| | Me | CO₂iPr | H |
| | Me | C(O)O, H₃N⁺Me | H |
| | Me | C(O)O, HN⁺(Me)₃ | H |
| | Me | C(O)O, N⁺(Me)₄ | H |
| | Me | C(O)O, Na⁺ | H |
| | Me | OCH₂CO₂H | H |
| | Me | CO₂H | F |
| | Me | CO₂Me | F |
| | Me | CO₂Et | F |
| | Me | CO₂Pr | F |
| | Me | CO₂iPr | F |
| | Me | C(O)O, H₃N⁺Me | F |
| | Me | C(O)O, HN⁺(Me)₃ | F |
| | Me | C(O)O, N⁺(Me)₄ | F |
| | Me | C(O)O, Na⁺ | F |
| | Me | OCH₂CO₂H | F |
| | Me | CO₂H | Cl |
| | Me | CO₂Me | Cl |
| | Me | CO₂Et | Cl |
| | Me | CO₂Pr | Cl |
| | Me | CO₂iPr | Cl |
| | Me | C(O)O, H₃N⁺Me | Cl |
| | Me | C(O)O, HN⁺(Me)₃ | Cl |
| | Me | C(O)O, N⁺(Me)₄ | Cl |
| | Me | C(O)O, Na⁺ | Cl |
| | Me | OCH₂CO₂H | Cl |
| 28 | Cl | CO₂H | H |
| | Cl | CO₂Me | H |
| | Cl | CO₂Et | H |
| | Cl | CO₂Pr | H |
| | Cl | CO₂iPr | H |
| | Cl | C(O)O, H₃N⁺Me | H |
| | Cl | C(O)O, HN⁺(Me)₃ | H |
| | Cl | C(O)O, N⁺(Me)₄ | H |
| | Cl | C(O)O, Na⁺ | H |
| | Cl | OCH₂CO₂H | H |
| | Cl | CO₂H | F |
| | Cl | CO₂Me | F |
| | Cl | CO₂Et | F |
| | Cl | CO₂Pr | F |
| | Cl | CO₂iPr | F |
| | Cl | C(O)O, H₃N⁺Me | F |
| | Cl | C(O)O, HN⁺(Me)₃ | F |
| | Cl | C(O)O, N⁺(Me)₄ | F |
| | Cl | C(O)O, Na⁺ | F |
| | Cl | OCH₂CO₂H | F |
| | Cl | CO₂H | Cl |
| | Cl | CO₂Me | Cl |
| | Cl | CO₂Et | Cl |
| | Cl | CO₂Pr | Cl |
| | Cl | CO₂iPr | Cl |
| | Cl | C(O)O, H₃N⁺Me | Cl |
| | Cl | C(O)O, HN⁺(Me)₃ | Cl |
| | Cl | C(O)O, N⁺(Me)₄ | Cl |
| | Cl | C(O)O, Na⁺ | Cl |
| 27 | Cl | OCH₂CO₂H | Cl |

### Formulation/Utility

Useful formulations employed in the present invention can be prepared in conventional ways. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient(s) can be (micro)encapsulated and further formed into a suspension or solid formulation; alternatively the entire formulation of active ingredient can be encapsulated (or “overcoated”). Encapsulation can control or delay release of the active ingredient(s). Sprayable formulations can be extended in suitable media and used at spray volumes from about one to several hundred liters per hectare. High-strength compositions are primarily used as intermediates for further formulation.

The formulations will typically contain effective amounts of active ingredient(s), diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets | | | |
| and Powders. | | | |
| Suspensions, Emulsions, | 1-50 | 40-99 | 0-50 |
| Solutions (including | | | |
| Emulsifiable Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Typical solid diluents are described in Watkins et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Typical surfactants which may be utilized include calcium lignin sulfonate, polyoxyethyleneoctylphenol ethers and naphthalenesulfonic acids and their salts, phenolsulfonic acids and their salts, formaldehyde condensates, fatty alcohol sulfates, and substituted benzenesulfonic acids and their salts. Particularly useful in formulations employed in the present invention are surfactants (i.e. surface-active compounds) having one or more phosphate groups that are partially (not fully) esterified and in which the esterified acid radicals are esterified with compounds selected from the following group of alcohol components:
(a) alkanols having, for example, 1 to 22 carbon atoms, preferably 1 to 12 carbon atoms, in particular from 4 to 12 or 4 to 8 carbon atoms, or unsubstituted or substituted cycloalkanols having preferably 5 to 12 carbon atoms, e.g. cyclohexanol, alkylcyclohexanols, cyclopentanol;
(b) oxyalkylated alkanols having up to 24 carbon atoms in the alkyl radical and 1 to 150 alkyleneoxy units in the alkyleneoxy or polyalkyleneoxy moiety, preferably those having 4 to 22 carbon atoms, in particular 10 to 20 carbon atoms in the alkyl radical and 1 to 60, in particular 3 to 30 alkyleneoxy units in the alkyleneoxy or polyalkyleneoxy moiety;
(c) phenol or oxyalkylated phenol, where the phenyl radical is in each case unsubstituted or substituted by 1 to 3 alkyl radicals having preferably in each case 4 to 12 carbon atoms or by 1 to 3 aryl or arylalkyl radicals having 6 to 12 carbon atoms, and having, in the oxyalkylated case, 1 to 150 alkyleneoxy units in the alkyleneoxy or polyalkyleneoxy moiety, preferably oxyalkylated phenol having 1 to 20 alkyleneoxy units or oxyalkylated phenol which is substituted by 1 to 3 alkyl radicals having in each case 4 to 12 carbon atoms and has 1 to 60, in particular 4 to 30, alkyleneoxy units, or oxyalkylated phenol which is substituted by 1 to 3 aryl or arylalkyl radicals having 6 to 12 carbon atoms and has 1 to 100, in particular 10 to 30, alkyleneoxy units; and
(d) oxyalkylated alkylamines having, for example, up to 24 carbon atoms in the alkyl moiety and 1 to 150 alkyleneoxy units in the polyalkyleneoxy moieties, so that the tensides are e.g. phosphated alkoxylated alkylamines such as ethoxylated C₈-C₂₂ fatty amines.

Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, glycerine, triacetine, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, acetates such as hexyl acetate, heptyl acetate and octyl acetate, and alcohols such as methanol, cyclohexanol, decanol, benzyl and tetrahydrofurfuryl alcohol.

Useful formulations of this invention may also contain materials well known to those skilled in the art as formulation aids such as antifoams, film formers and dyes. Antifoams can include water dispersible liquids comprising polyorganosiloxanes like Rhodorsil® 416. The film formers can include polyvinyl acetates, polyvinyl acetate copolymers, polyvinylpyrrolidone-vinyl acetate copolymer, polyvinyl alcohols, polyvinyl alcohol copolymers and waxes. Dyes can include water dispersible liquid colorant compositions like Pro-lzed® Colorant Red. One skilled in the art will appreciate that this is a non-exhaustive list of formulation aids. Suitable examples of formulation aids include those listed herein and those listed in McCutcheon's 2001, Volume 2: Functional Materials published by MC Publishing Company and PCT Publication WO 03/024222.

While a compound of Formula 1 can be used alone to inhibit regrowth in plants, it generally is applied to plants in conjunction with other substances, such as, carrier vehicles, wetting agents, emulsifiers, and solvents. Exemplary carrier vehicles include water, aliphatic or aromatic hydrocarbons, such as benzene, toluene, xylene, cyclohexanone, isophorone and mineral or vegetable oil fractions. The particularly preferred carrier vehicle is water, based on its availability and cost.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

The optimal time to apply the compounds of Formula 1 to cotton being conditioned for harvest, with or without other harvest aids selected from defoliants or desiccants, is mainly based on the maturity of cotton bolls and/or the percent of cotton bolls that are open or unopen, though weather and plant conditions can also be factors. Defoliation that occurs too early may result in lower yield and quality. Defoliation that occurs too late may increase the chance of boll rot and may be less effective as a result of lower temperatures. The harvest aids of the present invention are preferably applied to cotton fields at the time when 5% to 95% of cotton bolls have opened.

In order to effectively inhibit regrowth in a crop plant being conditioned for harvest or after harvest, the compound of Formula 1 is applied to the foliage of the crop plant at about 0.0001 to 20 kilograms per hectare (kg/ha) with a preferred range of about 0.001 to 5 kg/ha and a more preferred range of about 0.004 to 3 kg/ha. One skilled in the art can easily determine the regrowth-inhibiting effective amount necessary for the desired level of regrowth inhibition.

The combined concentrations of the compounds of Formula 1 and at least one compound selected from compounds acting as defoliants or desiccants in the composition of the present invention is generally at least about 25 wt. %, preferably at least about 40 wt. %, and more preferably at least about 50 wt. % based upon the total weight of the composition. For field application to plants, the composition is typically diluted to contain from about 1 to about 80 wt. % of the active agents, about 20 to about 99 wt. % of a solid or liquid carrier vehicle, and optionally up to about 20 wt. % of a surface-active substance.

The ratio of the weight of the compound of Formula 1 to the weight of the component acting as a defoliant or desiccant (i.e. the at least one compound acting as a defoliant or desiccant) is typically about 1:500 to about 100:1. Another effective weight ratio is about 1:500 to about 40:1 or about 1:100 to about 1:1. When the compounds of Formula 1 and the component selected from compounds acting as a defoliant or desiccant have similar molecular weights, the general and preferred ranges for the ratio of the moles of the compound of Formula 1 to the moles of the compound acting as a defoliant or desiccant are comparable to the above weight ratio ranges. The optimum ratios can be easily determined by those skilled in the art based on the combination of harvest aid activities desired.

The mixture of the present invention has been found to be highly effective for defoliation or desiccation and regrowth inhibition of plants, such as cotton, when the amount of the composition of the active ingredients in this present invention applied is at least about 0.005, preferably about 0.005 to about 12.5, and more preferably about h to about 9.5 kilograms per hectare (kg/ha). One skilled in the art will recognize that the use rates of the combination of the present invention that are effective as harvest aids can be determined through typical testing.

When the composition of the present invention is sprayed from the ground, it is generally diluted with a carrier vehicle (for example, water) to provide a spray volume from about 9 to about 2,000 liters per hectare (L/ha). Preferably, a spray volume of about 47 to about 500 L/ha is utilized. In the case of aerial spraying, a more concentrated solution is commonly used and typically applied at a rate of about 18 to about 140, and preferably about 19 to about 95 L/ha.

In the context of the present invention compounds of Formula 1 can be used alone or in combination with herbicides, insecticides and fungicides, and other agricultural chemicals such as fertilizers. Examples of such herbicides with which compounds of this invention can be formulated are: bromoxynil, carfentrazone-ethyl, chlorimuron-ethyl, chlorsulfuron, clethodim, diflufenzopyr, diuron, fenoxaprop-ethyl, fluazifop-P-butyl, fluometuron, glyphosate and its salts such as ammonium, isopropyl ammonium and trimesium, lactofen, linuron, methylarsonic acid and its calcium, monoammonium, monosodium and disodium salts, metsulfuron-methyl, nicosulfuron, oxyfluorfen, paraquat dichloride, prometryn, pyrithiobac, pyrithiobac-sodium, quizalofop-ethyl, quizalofop-P-ethyl, rimsulfuron, sethoxydim, sulfometuron-methyl, thifensulfuron-methyl, tribenuron-methyl, Examples of such insecticides with which compounds of this invention can be formulated are: abamectin, acephate, azinphos-methyl, bifenthrin, buprofezin, carbofuran, chlorfenapyr, chlorpyrifos, chlorpyrifos-methyl, cyflumetofen, cyfluthrin, beta-cyfluthrin, cyhalothrin, lambda-cyhalothrin, deltamethrin, diafenthiuron, diazinon, diflubenzuron, dimefluthrin, dimethoate, dinotefuran, esfenvalerate, fenoxycarb, fenpropathrin, fenvalerate, fipronil, flonicamid, flubendiamide, flucythrinate, tau-fluvalinate, fonophos, imidacloprid, indoxacarb, isofenphos, malathion, metaflumizone, metaldehyde, methamidophos, methidathion, methomyl, methoprene, methoxychlor, metofluthrin, monocrotophos, noviflumuron, oxamyl, parathion, parathion-methyl, permethrin, phorate, phosalone, phosmet, phosphamidon, pirimicarb, profenofos, profluthrin, pyrafluprole, pyridalyl, pyriprole, rotenone, spirodiclofen, spiromesifen, spirotetramat, sulprofos, tebufenozide, tefluthrin, terbufos, tetrachlorvinphos, thiamethoxam, thiodicarb, tralomethrin, trichlorfon and triflumuron.

Of note is a method of the present invention in which a compound of Formula 1 is combined or used with at least one defoliant or desiccant compound selected from the group consisting of tribufos (S,S,S-tributylphosphorotrithioate), dimethipin, thidiazuron, diuron, carfentrazone-ethyl, pyraflufen, ethephon, cyclanilide, AMADS (1-aminomethanamide dihydrogen tetraoxosulfate), sodium chlorate, paraquat, glyphosate, endothal, cacodylic acid, urea phosphate and their agriculturally suitable salts. Also of note is a mixture comprising a compound of Formula 1 and a component consisting of at least one compound or mixture selected from the group consisting of tribufos, thidiazuron, ethephon, cyclanilide, AMADS, sodium chlorate, cacodylic acid, urea phosphate and their agriculturally suitable salts. For said method and mixture of note, one skilled in the art recognizes which of the components listed can form agriculturally suitable salts and also recognizes that some of components listed (e.g., AMADS, sodium chlorate, urea phosphate) are themselves salts.

Specifically preferred mixtures (compound numbers refer to compounds listed as Specific Embodiments in the Details of the Invention) are selected from the group consisting of: the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with tribufos, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with dimethipin, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with thidiazuron, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with a mixture of thidiazuron and diuron, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with a mixture of thidiazuron and dimethipin, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with carfentrazone-ethyl, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with pyraflufen, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with ethephon, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with a mixture of ethephon and cyclanilide, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with a mixture of ethephon and AMADS, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with sodium chlorate, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with paraquat, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with glyphosate, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with endothal, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with cacodylic acid, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with a mixture of sodium cacodylate and cacodylic acid, the combinations of Compound 1, Compound 2, Compound 3, Compound 4, Compound 5, Compound 6, Compound 7, Compound 8, Compound 9, Compound 10, Compound 11, Compound 12, Compound 13, Compound 14, Compound 15, Compound 16, Compound 17, Compound 18, Compound 19, Compound 20, Compound 21, Compound 22, Compound 23, Compound 24, Compound 25 or Compound 26 with a mixture of ethephon and urea phosphate. Also specifically preferred mixtures (compound numbers refer to compounds listed as Specific Embodiments in the Details of the Invention) are selected from the group consisting of: the combinations of Compound 27, Compound 28, Compound 29 or Compound 30 with tribufos, the combinations of Compound 27, Compound 28, Compound 29 or Compound 30 with dimethipin, the combinations of Compound 27, Compound 28, Compound 29 or Compound 30 with thidiazuron, the combinations of Compound 27, Compound 28, Compound 29 or Compound 30 with a mixture of thidiazuron and diuron, the combinations of Compound 27, Compound 28, Compound 29 or Compound 30 with a mixture of thidiazuron and dimethipin, the combinations of Compound 27, Compound 28, Compound 29 or Compound 30 with carfentrazone-ethyl, the combinations of Compound 27, Compound 28, Compound 29 or Compound 30 with pyraflufen, the combinations of Compound 27, Compound 28, Compound 29 or Compound 30 with ethephon, the combinations of Compound 27, Compound 28, Compound 29 or Compound 30 with a mixture of ethephon and cyclanilide, the combinations of Compound 27, Compound 28, Compound 29 or Compound 30 with a mixture of ethephon and AMADS, the combinations of Compound 27, Compound 28, Compound 29 or Compound 30 with sodium chlorate, the combinations of Compound 27, Compound 28, Compound 29 or Compound 30 with paraquat, the combinations of Compound 27, Compound 28, Compound 29 or Compound 30 with glyphosate, the combinations of Compound 27, Compound 28, Compound 29 or Compound 30 with endothal, the combinations of Compound 27, Compound 28, Compound 29 or Compound 30 with cacodylic acid, the combinations of Compound 27, Compound 28, Compound 29 or Compound 30 with a mixture of sodium cacodylate and cacodylic acid, and the combinations of Compound 27, Compound 28, Compound 29 or Compound 30 with a mixture of ethephon and urea phosphate.

The following Tests demonstrate the regrowth inhibition efficacy of the compounds of Formula 1 in cotton crops. The regrowth inhibition afforded by the compounds is not limited, however, to this species.

### Biological Examples of the Invention

### Test A

A field trial was conducted to evaluate the effects of mixtures of Compound 4 with commercial harvest aids on cotton (GOSHI, Gossypium hirsutum L.). Cotton seeds (cv. ‘Fibermax FM 989 RR’) were planted in mid spring season, 3.8 cm deep in a clay soil having 1.8% organic matter and a pH of 6.8. Plots were 9 m long by 3 m wide with rows spaced 96.5 cm apart. Seeds were spaced 10.2 cm apart within the rows. The field was managed using conventional tillage practices, and applications of herbicides and insecticides were used to maintain a healthy crop. The plots were arranged in a randomized complete block design with each treatment being replicated three times. Treatments were applied preharvest over the top of the crop in late summer, when approximately 65% of the bolls had opened, using a backpack sprayer delivering a spray volume of 140 L/ha using a pressure of 276 kPa. Treatments consisted of the commercial harvest aids tribufos and ethephon+AMADS alone and in combination with Compound 4, dissolved or suspended in water. The effects on the treated plants and untreated controls were recorded 4, 11 and 21 days after application. Plants were visually evaluated for harvest aid effects of boll opening, defoliation, desiccation, and whole plant (basal and terminal) regrowth inhibition. Results were calculated as the mean of the three replicates, based on a scale of 0 to 100 where 0 is no effect and 100 is complete expression of the effect.

### Test B1

A field trial was conducted to evaluate the effects of mixtures of Compound 4 with commercial harvest aids on cotton (GOSHI, Gossypium hirsutum L.). Delta and Pine Land Co. cotton seeds (cv. ‘DP 434’) were planted in mid spring season, 3.8-cm deep in a fine-texture loam soil comprising 40% sand, 36% silt, and 24% clay. Soil organic matter was 1.8%; pH was 6.6. Plots were 9.1 m long by 3.0 m wide with rows spaced 96.5 cm apart. Seeds were spaced 10.2 cm apart within the rows. The field was managed using conventional tillage practices, and applications of herbicides and insecticides were used to maintain a healthy crop. The plots were arranged in a randomized complete block design with each treatment being replicated four times. Treatments were applied preharvest over the top of the crop in late summer, when approximately 65% of the bolls had opened, using a tractor-mounted sprayer delivering a spray volume of 140 L/ha at a pressure of 241 kPa. Treatments consisted of the commercial harvest aids tribufos, ethephon, and ethephon+AMADS alone and in combination with Compound 4, dissolved or suspended in water. Plants were evaluated for harvest aid effects including defoliation and regrowth inhibition at 4, 7, 14, and/or 22 days after application (DAA). Individual results were recorded and data reported as the means of the three replicates.

### Test B2

A field trial was conducted to evaluate the effects of mixtures of Compound 4 with commercial harvest aids on cotton (GOSHI, Gossypium hirsutum L.). Delta and Pine Land Co. cotton seeds (cv. ‘DP 117BRIIRF’) were planted in mid spring season, 2.0-cm deep in a clay soil. Plots were 12.19 m long by 3.86 m wide with rows spaced 96.5 cm apart. The field was managed using conventional tillage practices, and applications of herbicides and insecticides were used to maintain a healthy crop. The plots were arranged in a randomized complete block design with each treatment being replicated four times. Treatments were applied preharvest over the top of the crop in late summer, when approximately 65% of the bolls had opened, using a tractor-mounted sprayer delivering a spray volume of 140.3 L/ha at a pressure of 193 kPa. Treatments consisted of the commercial harvest aids tribufos, ethephon, and ethephon+AMADS alone and in combination with Compound 4, dissolved or suspended in water. Plants were evaluated for harvest aid effects including defoliation and regrowth inhibition at 4, 7, and 14 DAA. Individual results were recorded and data reported as the means of the three replicates.

Results for Tests A, B1 and B2 are given in Table A, B1 and B2 respectively. Plants were visually evaluated for harvest aid effects of boll opening, defoliation, desiccation, and whole plant (basal and terminal) regrowth inhibition. “State of Defoliation (%)” represents a visual rating at a given DAA of the overall reduction in foliage on treated plants in a plot. It is based on a scale of 0 to 100%, where 0 represents an amount of foliage similar to control plants, and 100 indicates no leaves present. Plant regrowth assessments at a given DAA were made relative to appropriate controls after effects of defoliation were observed. Regrowth of the basal (“plant stalk”, below the top 15.3 cm of the plants) and terminal (“plant terminal”, top 15.3 cm of the plants) portions of the plants were separately evaluated on a visual rating scale of 0 to 100%, where 0 indicates no regrowth, and 100 indicates complete regrowth. The regrowth evaluations involved overall assessment of renewed or continued growth and development, which included: node and internodal development and elongation, and leaf formation, development and growth. These regrowth evaluations were recorded as “Regrowth %” and subsequently converted in the tables to “Regrowth Inhibition (%)”, which was calculated as 100%−Y_{T}, where Y_{T} equals the mean Regrowth % of three replicates for a respective treatment.

TABLE A
Results of Preharvest Applications to Cotton of Tribufos and Ethephon + AMADS Alone
and in Combination with Compound 4

| | | Boll | | State of | | | | | Regrowth |
|---|---|---|---|---|---|---|---|---|---|
| | | Opening | | Defoliation | | | Desiccation | | Inhibition |
| | | (%) | | (%) | | | (%) | | (%) |
| | | Observation Timing | | | | | | | |
| Preharvest Application | Application | (DAA; Days After Application) | | | | | | | |
| Treatment | Rate^{a} | 4 | 11 | 4 | 11 | 21 | 4 | 11 | 21 |
| Ethephon + AMADS | 1278 | 70 | 85 | 65 | 80 | 35 | 25 | 10 | 25 |
| (Ethephon + AMADS) + | 958 + 15 | 67 | 83 | 30 | 73 | 93 | 23 | 22 | 97 |
| Compound 4 | | | | | | | | | |
| (Ethephon + AMADS) + | 958 + 45 | 67 | 82 | 25 | 65 | 96 | 23 | 25 | 98 |
| Compound 4 | | | | | | | | | |
| (Ethephon + AMADS) + | 958 + 90 | 63 | 82 | 17 | 65 | 94 | 22 | 25 | 98 |
| Compound 4 | | | | | | | | | |
| Tribufos | 841 | 70 | 78 | 68 | 80 | 35 | 32 | 8 | 25 |
| Tribufos + | 841 + 45 | 68 | 77 | 25 | 75 | 93 | 60 | 13 | 96 |
| Compound 4 | | | | | | | | | |
| Untreated | | 67 | 73 | 17 | 0 | 25 | 0 | 0 | 0 |

^{a}Application rates are grams active ingredient per hectare (g a.i./ha).

As can be seen in Table A, combination with Compound 4 dramatically increased defoliation and regrowth inhibition compared to ethephon+AMADS or tribufos alone at 21 days after application. Combination with Compound 4 also increased desiccation at 11 days after application compared to ethephon+AMADS or tribufos alone. Combination with Compound 4 did not interfere with the boll opening effects of the commercial harvest aids alone compared to the untreated plants. The high percentage of regrowth inhibition from treatments including Compound 4 indicate that Compound 4 is effective for inhibiting both basal and terminal regrowth.

TABLE B1
Defoliation and Regrowth Inhibition Results of Preharvest Applications to Cotton of
Tribufos, Ethephon, Ethephon plus AMADS, Alone and in Combination with Compound 4

| | | | | | Plant Terminal | Plant Stalk | Plant Stalk |
|---|---|---|---|---|---|---|---|
| | | State of | | | (Top 15.3-cm) | (Below 15.3-cm) | (Below 15.3-cm) |
| | | Defoliation | | | Regrowth Inhibition | | |
| | | (%) | | | (%) | | |
| | | Observation Timing | | | | | |
| Preharvest Application | Application | (DAA; Days After Application) | | | | | |
| Treatment | Rate^{a} | 4 | 7 | 14 | 14 | | 22 |
| Tribufos | 421 | 49 | 76 | 81 | 47 | 84 | 29 |
| Ethephon | 1262 | 54 | 73 | 79 | 75 | 90 | 22 |
| Ethephon + AMADS | 1277 + 4091 | 61 | 81 | 83 | 75 | 87 | 45 |
| Ethephon + | 1262 + 5 | 24 | 34 | 61 | 100 | 100 | 84 |
| Compound 4 | | | | | | | |
| Ethephon + | 1262 + 10 | 21 | 34 | 43 | 100 | 100 | 87 |
| Compound 4 | | | | | | | |
| Ethephon + | 1262 + 20 | 21 | 34 | 48 | 100 | 100 | 96 |
| Compound 4 | | | | | | | |
| (Ethephon + Tribufos) + | 1262 + 421 + 5 | 25 | 53 | 68 | 100 | 100 | 80 |
| Compound 4 | | | | | | | |
| (Ethephon + Tribufos) + | 1262 + 421 + 10 | 28 | 45 | 51 | 97 | 100 | 92 |
| Compound 4 | | | | | | | |
| (Ethephon + Tribufos) + | 1262 + 421 + 20 | 23 | 49 | 36 | 100 | 99 | 90 |
| Compound 4 | | | | | | | |
| (Ethephon + AMADS) + | 1277 + 4091 + 5 | 30 | 60 | 70 | 100 | 100 | 90 |
| Compound 4 | | | | | | | |
| (Ethephon + AMADS) + | 1277 + 4091 + 10 | 18 | 45 | 50 | 100 | 100 | 86 |
| Compound 4 | | | | | | | |
| (Ethephon + AMADS) + | 1277 + 4091 + 20 | 23 | 28 | 36 | 99 | 100 | 92 |
| Compound 4 | | | | | | | |
| Compound 4 | 5 | 13 | 18 | 23 | 100 | 100 | 100 |
| Compound 4 | 10 | 8 | 18 | 21 | 100 | 100 | 100 |
| Compound 4 | 20 | 13 | 24 | 23 | 100 | 100 | 100 |

^{a}Application rates are grams active ingredient per hectare (g a.i./ha).

TABLE B2
Defoliation and Regrowth Inhibition Results of Preharvest Applications to Cotton of
Tribufos, Ethephon, Ethephon plus AMADS, Alone and in Combination with Compound 4

| | | | | | Plant Terminal | Plant Stalk |
|---|---|---|---|---|---|---|
| | | State of | | | (Top 15.3-cm) | (Below 15.3-cm) |
| | | Defoliation | | | Regrowth Inhibition | |
| | | (%) | | | (%) | |
| | | Observation Timing | | | | |
| Preharvest Application | Application | (DAA; Days After Application) | | | | |
| Treatment | Rate^{a} | 4 | 7 | 14 | 14 | |
| Tribufos | 421 | 50 | 56 | 53 | 44 | 81 |
| Ethephon | 1262 | 58 | 63 | 48 | 60 | 80 |
| Ethephon + AMADS | 1277 + 4091 | 69 | 69 | 70 | 66 | 86 |
| Ethephon + | 1262 + 5 | 1 | 8 | 23 | 100 | 100 |
| Compound 4 | | | | | | |
| Ethephon + | 1262 + 10 | 8 | 9 | 23 | 100 | 100 |
| Compound 4 | | | | | | |
| Ethephon + | 1262 + 20 | 5 | 9 | 18 | 100 | 100 |
| Compound 4 | | | | | | |
| (Ethephon + Tribufos) + | 1262 + 421 + 5 | 14 | 21 | 45 | 99 | 99 |
| Compound 4 | | | | | | |
| (Ethephon + Tribufos) + | 1262 + 421 + 10 | 9 | 14 | 40 | 100 | 100 |
| Compound 4 | | | | | | |
| (Ethephon + Tribufos) + | 1262 + 421 + 20 | 8 | 11 | 33 | 100 | 100 |
| Compound 4 | | | | | | |
| (Ethephon + AMADS) + | 1277 + 4091 + 5 | 6 | 10 | 18 | 100 | 100 |
| Compound 4 | | | | | | |
| (Ethephon + AMADS) + | 1277 + 4091 + 10 | 5 | 10 | 18 | 100 | 100 |
| Compound 4 | | | | | | |
| (Ethephon + AMADS) + | 1277 + 4091 + 20 | 14 | 15 | 30 | 100 | 100 |
| Compound 4 | | | | | | |
| Compound 4 | 5 | 3 | 4 | 10 | 97 | 100 |
| Compound 4 | 10 | 3 | 4 | 11 | 100 | 100 |
| Compound 4 | 20 | 4 | 9 | 15 | 100 | 100 |

^{a}Application rates are grams active ingredient per hectare (g a.i./ha).

As can be seen in Tables B1 and B2, the addition of Compound 4 to the mixtures dramatically increased regrowth inhibition compared to ethephon, ethephon+AMADS, or tribufos treatments alone on plant terminal and plant stalk evaluations, evaluated at 14 DAA. The high percentage of regrowth inhibition from treatments including Compound 4 indicates that Compound 4 is effective for inhibiting both basal and terminal regrowth.

What is claimed is:

1. A method for inhibiting regrowth of foliage of a cotton plant being conditioned for harvest or after harvest comprising applying to the plant foliage a regrowth-inhibiting effective amount of a compound of Formula 1, an N-oxide or a salt thereof, 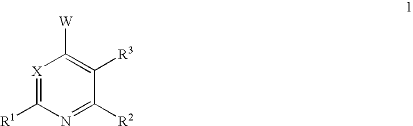
wherein
R¹ is halogen; or C₁-C₄ alkyl, C₂-C₄ alkenyl, C₃-C₅ cycloalkyl, C₂-C₆ alkoxyalkyl, C₂-C₆ alkylthioalkyl, each optionally substituted with 1-5 R⁵; or a phenyl or 5- or 6-membered heteroaromatic ring, each ring optionally substituted with 1 to 3 substituents independently selected from R⁶;
R² is ((O)ⱼC(R¹⁵)(R¹⁶))ₖR;
R is CO₂H or a regrowth-inhibiting effective derivative thereof;
R³ is halogen, cyano, thiocyano, nitro, C₁-C₆ alkyl, C₁-C₆ haloalkyl, OR⁷, SR⁸ or N(R⁹)R¹⁰;
W is H, —N(R¹¹)R¹², N₃ or —NO₂;
X is N or CR⁴;
R⁴ is H, halogen, C₁-C₆ alkyl, C₁-C₆ haloalkyl, C₁-C₆ alkoxy, C₁-C₆ haloalkoxy, C₁-C₆ alkylthio, phenoxy, nitro, cyano or thiocyano;
each R⁵ is independently halogen, C₁-C₆ alkyl, C₁-C₆ haloalkyl, C₂-C₆ alkenyl, C₂-C₆ haloalkenyl, C₁-C₃ alkoxy, C₁-C₂ haloalkoxy, C₁-C₃ alkylthio or C₁-C₂ haloalkylthio;
each R⁶ is independently halogen, cyano, nitro, C₁-C₄ alkyl, C₁-C₄ haloalkyl, C₃-C₆ cycloalkyl, C₃-C₆ halocycloalkyl, C₁-C₄ hydroxyalkyl, C₂-C₄ alkoxyalkyl, C₂-C₄ haloalkoxyalkyl, C₂-C₄ alkenyl, C₂-C₄ haloalkenyl, C₂-C₄ alkynyl, C₂-C₄ haloalkynyl, hydroxy, C₁-C₄ alkoxy, C₁-C₄ haloalkoxy, C₂-C₄ alkenyloxy, C₂-C₄ haloalkenyloxy, C₃-C₄ alkynyloxy, C₃-C₄ haloalkynyloxy, C₁-C₄ alkylthio, C₁-C₄ haloalkylthio or C₃-C₆ trialkylsilyl;
R⁷ is H, C₁-C₄ alkyl, C₁-C₃ haloalkyl or phenyl;
R⁸ is H, C₁-C₄ alkyl or C₁-C₃ haloalkyl;
R⁹ and R¹⁰ are independently H or C₁-C₄ alkyl;
R¹¹ is H, C₁-C₄ alkyl, C₁-C₄ haloalkyl, C₃-C₆ cycloalkyl, C₃-C₆ halocycloalkyl, C₁-C₄ hydroxyalkyl, C₂-C₄ alkoxyalkyl, C₂-C₄ haloalkoxyalkyl, C₂-C₄ alkenyl, C₂-C₄ haloalkenyl, C₃-C₄ alkynyl, C₃-C₄ haloalkynyl, C(═O)R³³ or nitro;
R¹² is H, C₁-C₄ alkyl optionally substituted with 1-2 R³⁰ or C(═O)R³³; or
R¹¹ and R¹² are taken together as a radical selected from —(CH₂)₄—, —(CH₂)₅—, —CH₂CH═CHCH₂— and —(CH₂)₂—O—(CH₂)₂—, each radical optionally substituted with 1-2 R⁴⁰; or
R¹⁵ is H, halogen, C₁-C₄ alkyl, C₁-C₄ haloalkyl, hydroxy, C₁-C₄ alkoxy or C₂-C₄ alkylcarbonyloxy;
R¹⁶ is H, halogen, C₁-C₄ alkyl or C₁-C₄ haloalkyl; or
R¹⁵ and R¹⁶ are taken together as an oxygen atom to form, with the carbon atom to which they are attached, a carbonyl moiety;
each R³⁰ is independently halogen, C₁-C₃ alkoxy, C₁-C₃ haloalkoxy, C₁-C₃ alkylthio, C₁-C₃ haloalkylthio, amino, C₁-C₃ alkylamino, C₂-C₄ dialkylamino or C₂-C₄ alkoxycarbonyl;
each R³³ is independently H, C₁-C₁₄ alkyl, C₁-C₃ haloalkyl, C₁-C₄ alkoxy, phenyl, phenoxy or benzyloxy;
each R⁴⁰ is independently halogen, C₁-C₃ alkyl, C₁-C₃ alkoxy, C₁-C₃ haloalkoxy, C₁-C₃ alkylthio, C₁-C₃ haloalkylthio, amino, C₁-C₃ alkylamino, C₂-C₄ dialkylamino or C₂-C₄ alkoxycarbonyl;
j is 0 or 1; and
k is 0 or 1;
provided that:
(a) when k is 0, then j is 0;
(b) when R² is CH₂OR^{a} wherein R^{a} is H, optionally substituted alkyl or benzyl, then R³ is other than cyano;
(c) when R¹ is phenyl substituted by Cl in each of the meta positions, the phenyl is also substituted by R⁶ in the para position; and
(d) when R¹ is phenyl substituted by R⁶ in the para position, said R⁶ is other than tert-butyl, cyano or optionally substituted phenyl.

2. The method of claim 1 wherein
R² is ((O)ⱼC(R¹⁵)(R¹⁶))ₖR;
R is CO₂R⁵¹, CH₂OR⁵², CH(OR⁵³)(OR⁵⁴), CHO, C(═O)N(R⁵⁵)R⁵⁶, C(═S)OR⁵⁷, C(═O)SR⁵⁸ or C(═NR⁵⁹)YR⁶⁰;
R⁵¹ is H or a radical selected from C₁-C₁₄ alkyl, C₃-C₁₂ cycloalkyl, C₄-C₁₂ alkylcycloalkyl, C₄-C₁₂ cycloalkylalkyl, C₂-C₁₄ alkoxyalkyl, C₃-C₁₄ alkoxyalkoxyalkyl, C₂-C₁₄ hydroxyalkyl, C₂-C₁₄ alkenyl, C₂-C₁₄ alkynyl, benzyl and phenyl, each radical optionally substituted with 1-3 R⁶¹; or
R⁵¹ is a divalent radical linking the carboxylic ester function CO₂R⁵¹ of each of two pyrimidine ring systems of Formula 1, the divalent radical selected from —CH₂—, —(CH₂)₂—, —(CH₂)₃— and —CH(CH₃)CH₂—;
R⁵² is H, C₁-C₁₀ alkyl optionally substituted with 1-3 R⁶², or benzyl;
R⁵³ and R⁵⁴ are independently C₁-C₄ alkyl or C₁-C₃ haloalkyl; or
R⁵³ and R⁵⁴ are taken together as —CH₂CH₂—, —CH₂CH(CH₃)— or —(CH₂)₃—;
R⁵⁵ is H, C₁-C₄ alkyl, hydroxy or C₁-C₄ alkoxy;
R⁵⁶ is H or C₁-C₄ alkyl;
R⁵⁷ and R⁵⁸ are H; or a radical selected from C₁-C₁₄ alkyl, C₃-C₁₂ cycloalkyl, C₄-C₁₂ alkylcycloalkyl, C₄-C₁₂ cycloalkylalkyl, C₂-C₁₄ alkenyl and C₂-C₁₄ alkynyl, each radical optionally substituted with 1-3 R⁶¹;
Y is O, S or NR⁶⁴;
R⁵⁹ is H, C₁-C₃ alkyl, C₁-C₃ haloalkyl, C₂-C₄ alkoxyalkyl, OH or C₁-C₃ alkoxy;
R⁶⁰ is C₁-C₃ alkyl, C₁-C₃ haloalkyl or C₂-C₄ alkoxyalkyl; or
R⁵⁹ and R⁶⁰ are taken together as —(CH₂)₂—, —CH₂CH(CH₃)— or —(CH₂)₃—;
each R⁶¹ is independently halogen, cyano, hydroxycarbonyl, C₂-C₄ alkoxycarbonyl, hydroxy, C₁-C₄ alkoxy, C₁-C₄ haloalkoxy, C₂-C₈ alkoxyalkoxy, C₁-C₄ alkylthio, C₁-C₄ haloalkylthio, amino, C₁-C₄ alkylamino, C₂-C₄ dialkylamino, —CHO(CH₂)ₚ or phenyl optionally substituted with 1-3 R⁶³;
each R⁶² is independently halogen, C₁-C₄ alkoxy, C₁-C₄ haloalkoxy, C₁-C₄ alkylthio, C₁-C₄ haloalkylthio, amino, C₁-C₄ alkylamino or C₂-C₄ dialkylamino;
each R⁶³ is independently halogen, C₁-C₄ alkyl, C₁-C₃ haloalkyl, hydroxy, C₁-C₄ alkoxy, C₁-C₃ haloalkoxy, C₁-C₃ alkylthio, C₁-C₃ haloalkylthio, amino, C₁-C₃ alkylamino, C₂-C₄ dialkylamino or nitro;
R⁶⁴ is H, C₁-C₃ alkyl, C₁-C₃ haloalkyl or C₂-C₄ alkoxyalkyl; and
p is an integer from 1 to 4.

3. The method of claim 2 wherein
R¹ is halogen; or C₁-C₃ alkyl or C₃-C₅ cycloalkyl, each optionally substituted with 1-2 R⁵; or a phenyl or 5- or 6-membered heteroaromatic ring, each ring optionally substituted with 1 to 3 substituents independently selected from R⁶;
R³ is halogen;
W is H or NH₂; and
R⁴ is H or halogen.

4. The method of claim 3 wherein
R¹ is C₃-C₅ cycloalkyl optionally substituted with 1-2 R⁵, or a phenyl or 5- or 6-membered heteroaromatic ring, each ring optionally substituted with 1 to 3 substituents independently selected from R⁶;
X is N;
each R⁵ is independently halogen, C₁-C₆ alkyl or C₁-C₆ haloalkyl; and
each R⁶ is independently halogen, cyano, nitro, C₁-C₄ alkyl, C₁-C₄ haloalkyl or C₁-C₄ alkoxy.

5. The method of claim 4 wherein R¹ is cyclopropyl or phenyl substituted with a halogen, methyl or methoxy radical in the para position and optionally with 1-2 radicals selected from halogen and methyl in other positions.

6. The method of claim 4 wherein
R² is CO₂H or a salt thereof, or R² is CO₂R⁵¹; and
R⁵¹ is benzyl, C₁-C₁₀ alkyl, C₂-C₁₀ alkoxyalkyl, C₃-C₁₀ alkoxyalkoxyalkyl or C₂-C₁₀ hydroxyalkyl.

7. The method of claim 6 wherein
R¹ is cyclopropyl, 4-Br-phenyl or 4-C₁-phenyl;
R² is CO₂H or a salt thereof, or R² is CO₂R⁵¹; and
R⁵¹ is C₁-C₂ alkyl.

8. The method of claim 6 wherein
R¹ is cyclopropyl, 4-Br-phenyl or 4-C₁-phenyl;
R² is CO₂R⁵¹; and
R⁵¹ is C₅-C₈ alkyl, C₅-C₈ alkoxyalkyl, C₅-C₈ alkoxyalkoxyalkyl or C₅-C₈ hydroxyalkyl.

9. The method of claim 1 wherein the compound of Formula 1 is selected from the group consisting of
methyl 6-amino-5-bromo-2-cyclopropyl-4-pyrimidinecarboxylate,
ethyl 6-amino-5-bromo-2-cyclopropyl-4-pyrimidinecarboxylate,
6-amino-5-bromo-2-cyclopropyl-4-pyrimidinecarboxylic acid monosodium salt,
methyl 6-amino-5-chloro-2-cyclopropyl-4-pyrimidinecarboxylate,
6-amino-5-chloro-2-cyclopropyl-4-pyrimidinecarboxylic acid monosodium salt,
ethyl 6-amino-5-chloro-2-cyclopropyl-4-pyrimidinecarboxylate,
methyl 6-amino-5-chloro-2-(4-chlorophenyl)-4-pyrimidinecarboxylate,
ethyl 6-amino-5-chloro-2-(4-chlorophenyl)-4-pyrimidinecarboxylate,
6-amino-5-chloro-2-(4-chlorophenyl)-4-pyrimidinecarboxylic acid,
ethyl 6-amino-2-(4-bromophenyl)-5-chloro-4-pyrimidinecarboxylate,
methyl 6-amino-2-(4-bromophenyl)-5-chloro-4-pyrimidinecarboxylate,
6-amino-2-(4-bromophenyl)-5-chloro-4-pyrimidinecarboxylic acid,
6-amino-5-bromo-2-cyclopropyl-4-pyrimidinecarboxylic acid,
6-amino-5-chloro-2-cyclopropyl-4-pyrimidinecarboxylic acid,
phenylmethyl 6-amino-5-bromo-2-cyclopropyl-4-pyrimidinecarboxylate,
phenylmethyl 6-amino-5-chloro-2-cyclopropyl-4-pyrimidinecarboxylate,
1-methylethyl 6-amino-5-chloro-2-cyclopropyl-4-pyrimidinecarboxylate,
butyl 6-amino-5-chloro-2-cyclopropyl-4-pyrimidinecarboxylate,
3-hydroxypropyl 6-amino-5-chloro-2-cyclopropyl-4-pyrimidinecarboxylate,
propyl 6-amino-5-chloro-2-cyclopropyl-4-pyrimidinecarboxylate,
1-methylheptyl 6-amino-5-chloro-2-cyclopropyl-4-pyrimidinecarboxylate,
2-(2-methoxyethoxy)ethyl 6-amino-5-chloro-2-cyclopropyl-4-pyrimidinecarboxylate,
octyl 6-amino-5-chloro-2-cyclopropyl-4-pyrimidinecarboxylate,
2-butoxyethyl 6-amino-5-chloro-2-cyclopropyl-4-pyrimidinecarboxylate,
2-ethylhexyl 6-amino-5-chloro-2-cyclopropyl-4-pyrimidinecarboxylate, and
2-butoxy-1-methylethyl 6-amino-5-chloro-2-cyclopropyl-4-pyrimidinecarboxylate.

10. The method of claim 5 wherein the compound of Formula 1 is methyl 6-amino-5-chloro-2-cyclopropyl-4-pyrimidinecarboxylate.

11. The method of claim 1 wherein the compound of Formula 1 is selected from the group consisting of
[(3,5,6-trichloro-2-pyridinyl)oxy]acetic acid,
3,6-dichloro-2-pyridinecarboxylic acid,
4-amino-3,6-dichloro-2-pyridinecarboxylic acid, and
4-amino-3,5,6-trichloro-2-pyridinecarboxylic acid.

12. The method of claim 1 wherein the compound of Formula 1 is applied with at least one compound selected from compounds acting as a defoliant or desiccant.

13. The method of claim 12 wherein the at least one defoliant or desiccant compound is selected from the group consisting of tribufos, thidiazuron, ethephon, cyclanilide, 1-aminomethanamide dihydrogen tetraoxosulfate, sodium chlorate, cacodylic acid, urea phosphate and their agriculturally suitable salts.

14. A mixture for causing prolonged defoliation of a cotton plant being conditioned for harvest comprising a compound of Formula 1 as defined in claim 1 and at least one compound selected from the group consisting of tribufos, thidiazuron, ethephon, cyclanilide, 1-aminomethanamide dihydrogen tetraoxosulfate, sodium chlorate, cacodylic acid, urea phosphate and their agriculturally suitable salts.

15. An agricultural composition comprising a compound of Formula 1 and at least one additional active ingredient selected from the group consisting of a herbicide or insecticide and at least one of a surfactant, and a solid or liquid diluent.

16. An agricultural composition comprising a mixture of claim 14 and at least one of a surfactant or solid or liquid diluent.

17. The method as claimed in claim 1 for inhibiting regrowth in a cotton plant wherein the compound is applied to a cotton plant being conditioned for harvest.

18. The method as claimed in claim 17, wherein the regrowth being inhibited is basal regrowth.

19. The method as claimed in claim 17, wherein the regrowth being inhibited is terminal regrowth.

20. The method as claimed in claim 1 for inhibiting regrowth in a cotton plant wherein the compound is applied after harvest.

21. The method as claimed in claim 20 wherein the regrowth being inhibited is basal regrowth.

22. The method as claimed in claim 20 wherein the regrowth being inhibited is terminal regrowth.
